(19) United States
(12) Patent Application Publication
(10) Pub. No.: US 2026/0366806 A1
(43) Pub. Date: Nov. 19, 2026

(54) WATER PURIFIER AND METHOD OF CONTROL THE SAME

(71) Applicant: COWAY Co., Ltd., Gongju-si (KR)

(72) Inventors: Moyoung GU, Gongju-si (KR); Jin Woo CHOI, Gongju-si (KR); Chung Rae KIM, Gongju-si (KR)

(73) Assignee: COWAY Co., Ltd., Gongju-si (KR)

(21) Appl. No.: 19/637,049

(22) Filed: Apr. 2, 2026

(30) Foreign Application Priority Data
May 19, 2025 (KR) 10-2025-0064403

(51) Int. Cl. F25D 31/00; C02F 1/00; F25D 23/12; F25D 29/00

(52) U.S. Cl. CPC F25D 31/003; F25D 23/126; F25D 29/00; F25D 31/005; C02F 1/003; C02F 2201/005; C02F 2307/12

(57) ABSTRACT

A water purifier is disclosed. A water purifier according to one aspect of the present disclosure includes a cold water tank configured to receive purified water and cool the purified water to generate cold water; a tray connected to the cold water tank and configured to receive the cold water, the tray having a tray space formed therein to accommodate the received cold water; a valve unit connected to the cold water tank; a flow path member partially accommodated in the tray space and connected to the valve unit to provide the cold water to the tray space; and a recovery pump connected to the valve unit and configured to provide a conveying force to the cold water remaining in the tray space, wherein the recovery pump is connected to the cold water tank and configured to recover the cold water remaining in the tray space to the cold water tank.

### CROSS-REFERENCE TO RELATED APPLICATION

The present application claims priority under 35 U.S.C. § 119(a) to Korean patent application number 10-2025-0064403 filed on May 19, 2025, in the Korean Intellectual Property Office, the entire disclosure of which is incorporated by reference herein.

### BACKGROUND

### 1. Technical Field

The present disclosure relates to a water purifier and a control method therefor, and more particularly, to a water purifier capable of recovering and reusing residual water generated after ice making, and a control method therefor.

### 2. Related Art

With improvements in living standards, demand related to ice provision has increased not only in commercial facilities but also in ordinary households. Conventionally, ice making has generally been performed using a freezer compartment provided in a refrigerator. A resident may fill water into an ice tray provided in the freezer compartment and cool the water to obtain ice.

Recently, water purifiers configured to provide purified water have increasingly been equipped with an ice making function. A water purifier generally refers to a device that filters source water supplied from outside to generate purified water and provides the purified water to a user. With advances in technology, water purifiers are capable of providing not only purified water but also hot water and cold water by including heating or cooling means.

Furthermore, in recent years, so-called “ice-making water purifiers,” which are capable of generating ice using purified water or cold water produced by the water purifier, have attracted significant attention.

A commonly used ice-making water purifier is configured such that purified water or cold water is accommodated in a container referred to as a tray, and an evaporator through which a refrigerant flows is partially immersed therein. Purified water or cold water may be frozen around a portion of the evaporator. Accordingly, it is difficult for all of the purified water or cold water accommodated in the tray to be frozen.

When residual water that is not frozen remains in the tray for an extended period of time, sanitary issues such as bacterial growth may occur. Therefore, an ice-making water purifier is generally configured to discharge residual water from the tray after ice making and ice separation.

However, as ice making and ice separation processes are repeated, the amount of residual water generated may increase. If the generated residual water is discarded, an amount of purified water or cold water corresponding to the discarded residual water is additionally required to be generated. As a result, usage or operation of components for generating purified water or cold water increases, which may reduce the service life of such components.

Accordingly, there is a need for a method for recovering and reusing residual water generated after ice making.

Korean Registered Patent No. 10-2773214 discloses an ice-making water purifier and a residual water discharge apparatus therefor. Specifically, the above patent document discloses an ice-making water purifier including a rotatably provided ice tray and a drain hole formed in a lower portion of an ice-making chamber accommodating separated ice, such that residual water and meltwater may be discharged.

However, the ice-making water purifier and the residual water discharge apparatus disclosed in the above patent document merely provide a method for discharging generated residual water or meltwater from the ice-making chamber. The above patent document does not provide a method for recovering the generated residual water and reusing the same.

Korean Registered Patent No. 10-2164577 discloses an ice-making water purifier for preventing internal contamination. Specifically, the above patent document discloses an ice-making water purifier including a separate filter unit for filtering ice and residual water, such that ice separated from an ice-making unit and residual water may be discharged separately.

However, the above patent document also merely provides a method for discharging residual water generated from an ice storage container. The above patent document does not provide a method for performing ice making again using the discharged residual water or providing the residual water to a user as cold water.

### Prior Art Document

### Patent Document

Korean Registered Patent No. 10-2773214 (Feb. 21, 2025)

Korean Registered Patent No. 10-2164577 (Oct. 5, 2020)

### DISCLOSURE

The present disclosure has been made to address the problems described above. An object of the present disclosure is to provide a water purifier having a structure capable of utilizing residual water generated during ice making, and a control method therefor.

Another object of the present disclosure is to provide a water purifier having a structure capable of preventing contamination of components caused by the generated residual water, and a control method therefor.

Another object of the present disclosure is to provide a water purifier having a structure capable of increasing the service life of components for generating purified water, and a control method therefor.

Another object of the present disclosure is to provide a water purifier having a structure in which usage of components for generating cold water is reduced and the service life thereof is increased, and a control method therefor.

Another object of the present disclosure is to provide a water purifier having a structure capable of improving energy efficiency, and a control method therefor.

The technical problems of the present disclosure are not limited to those mentioned above, and other problems not mentioned will be clearly understood by those of ordinary skill in the art from the following description.

According to one aspect of the present disclosure, a water purifier is provided, including a cold water tank configured to receive purified water, cool the purified water, and generate cold water; a tray connected to the cold water tank and having a tray space formed therein to receive and accommodate the cold water; a valve unit connected to the cold water tank; a flow path member partially accommodated in the tray space and connected to the valve unit to provide the cold water to the tray space; and a recovery pump connected to the valve unit and configured to provide a transfer force to the cold water remaining in the tray space, wherein the recovery pump is connected to the cold water tank such that the cold water remaining in the tray space is recovered to the cold water tank.

In this case, a water purifier may be provided in which the tray includes a tray bottom surface surrounding the tray space from below; a recessed surface continuous with the tray bottom surface and positioned lower than the tray bottom surface; and a recessed space surrounded at a lower side by the recessed surface and in fluid communication with the tray space, and the flow path member is positioned adjacent to the recessed space and disposed adjacent to a water surface of the cold water collected in the recessed space.

In addition, a water purifier may be provided in which the tray bottom surface extends in an inclined manner from one side opposite to the recessed space toward the recessed space.

In this case, a water purifier may be provided in which the flow path member includes a flow path housing having one portion accommodated in the tray and another portion connected to the valve unit.

In addition, a water purifier may be provided in which the flow path housing includes a housing body extending in a first direction; and a pipe part positioned adjacent to the housing body and having one end in an extension direction positioned in the tray space and another end in the extension direction connected to the valve unit to form a flow path through which the cold water is discharged from the tray.

In this case, a water purifier may be provided in which the flow path member further includes a flow path fitting coupled to the other end of the pipe part and connected to the valve unit.

In addition, a water purifier may be provided in which the water purifier further includes an evaporator partially accommodated in the tray space and forming a refrigerant flow path and the flow path member includes a cover member covering at least a portion of the evaporator from above and coupled to the flow path housing.

In this case, a water purifier may be provided in which the flow path housing includes a housing body extending in a first direction; a cover support portion positioned to be spaced apart from one end of the housing body along the first direction and configured to support the cover member from below; and an evaporator accommodating space formed between the housing body and the cover support portion and configured to accommodate the evaporator.

In addition, a water purifier may be provided in which the water purifier further includes a hot water tank configured to receive purified water and generate hot water; and a flow path unit connecting the hot water tank, the cold water tank, and the flow path member; the valve unit includes a multi-valve connected to the hot water tank, the cold water tank, and the flow path member, respectively; and the cold water tank is connected to the multi-valve at a plurality of points by a plurality of separated flow path units.

In this case, a water purifier may be provided in which the flow path unit includes a hot water supply flow path connecting the hot water tank and the multi-valve to provide the hot water to the multi-valve; a cold water supply flow path connecting the cold water tank and the multi-valve to provide the cold water to the multi-valve; and a recovery flow path configured independently from the cold water supply flow path and connecting the cold water tank and the multi-valve to provide the cold water recovered from the tray space to the cold water tank.

In addition, a water purifier may be provided in which the recovery pump is installed in the recovery flow path.

In this case, a water purifier may be provided in which the multi-valve is provided as a four-way valve and is connected to the flow path member, the hot water supply flow path, the cold water supply flow path, and the recovery flow path, respectively.

In addition, a water purifier may be provided in which the recovery flow path is connected to the cold water tank at a position closer to a lower side of the cold water tank in a height direction.

In this case, a water purifier may be provided in which the cold water tank includes a baffle member partitioning an internal space thereof into a plurality of small spaces continuously arranged in a zigzag shape, and the recovery flow path is connected to the cold water tank at a position adjacent to any one of the plurality of small spaces partitioned by the baffle member.

In addition, according to an aspect of the present disclosure, a method for controlling a water purifier may be provided, the method including (a) controlling, by a controller, a pump unit such that cold water is supplied from a cold water tank to a tray; (b) controlling, by the controller, an evaporator such that a refrigerant is supplied to the evaporator; and (c) controlling, by the controller, the pump unit such that cold water remaining in the tray is recovered to the cold water tank.

In this case, a method for controlling a water purifier may be provided in which the step (a) includes (a1) controlling, by the controller, a cold water valve such that a cold water supply flow path fluidically connecting the cold water tank and the tray is opened; and (a2) operating, by the controller, a cold water pump such that the cold water accommodated in the cold water tank is supplied to the tray.

In addition, a method for controlling a water purifier may be provided in which the step (b) includes (b1) stopping, by the controller, the cold water pump; (b2) controlling, by the controller, a cold water valve such that the cold water supply flow path is closed; (b3) operating, by the controller, the evaporator such that the refrigerant is introduced; and (b4) after a preset time has elapsed, stopping, by the controller, the evaporator such that introduction of the refrigerant is stopped.

In this case, a method for controlling a water purifier may be provided in which the step (c) includes (c1) controlling, by the controller, a multi-valve such that a recovery flow path fluidically connecting the cold water tank and the tray is opened; and (c2) operating, by the controller, a recovery pump such that the cold water remaining in the tray is recovered to the cold water tank.

In addition, a method for controlling a water purifier may be provided in which the method further includes, after the step (c), (d) controlling, by the controller, the pump unit such that cold water generated in the cold water tank and cold water recovered from the tray are supplied to the tray.

In this case, a method for controlling a water purifier may be provided in which the step (d) includes (d1) stopping, by the controller, the recovery pump; (d2) controlling, by the controller, a multi-valve such that a recovery flow path is closed; (d3) controlling, by the controller, a cold water valve such that a cold water supply flow path fluidically connecting the cold water tank and the tray is opened; and (d4) operating, by the controller, a cold water pump such that cold water generated in the cold water tank and cold water recovered from the tray are supplied to the tray.

In addition, a method for controlling a water purifier may be provided in which the method further includes, after the step (c) and before the step (d), (e) controlling, by the controller, a hot water tank such that hot water generated in the hot water tank is supplied to the tray.

In this case, a method for controlling a water purifier may be provided in which the step (e) includes (e1) stopping, by the controller, a cold water pump and a recovery pump; (e2) controlling, by the controller, a multi-valve such that a hot water flow path is opened; (e3) controlling, by the controller, the hot water tank such that hot water accommodated in the hot water tank is supplied to the tray through the multi-valve; and (e4) operating, by the controller, the tray such that the hot water is discharged.

According to the above-described configuration, the water purifier and the control method thereof according to an embodiment of the present disclosure can utilize residual water generated during ice making.

In addition, according to the above-described configuration, the water purifier and the control method thereof according to an embodiment of the present disclosure can prevent contamination of components caused by the generated residual water.

Further, according to the above-described configuration, the water purifier and the control method thereof according to an embodiment of the present disclosure can increase the service life of components for generating purified water.

In addition, according to the above-described configuration, the water purifier and the control method thereof according to an embodiment of the present disclosure can reduce the usage of components for generating cold water and increase the service life thereof.

Further, according to the above-described configuration, the water purifier and the control method thereof according to an embodiment of the present disclosure can improve energy efficiency.

Advantageous effects of the present disclosure are not limited to the above-described effects, and it should be understood that the present disclosure includes all effects that can be inferred from the configurations described in the detailed description or claims.

### BRIEF DESCRIPTION OF THE DRAWINGS

FIG. 1 is a perspective view illustrating a water purifier according to an exemplary embodiment of the present disclosure.

FIG. 2 is an exploded perspective view illustrating a configuration of the water purifier of FIG. 1.

FIG. 3 is a perspective view illustrating a tank unit and related components of the water purifier of FIG. 1.

FIG. 4 is a side view illustrating the tank unit and related components of FIG. 3.

FIG. 5 is a plan view illustrating the tank unit and related components of FIG. 3.

FIG. 6 is a side cross-sectional view taken along line A-A of FIG. 3, illustrating the tank unit and related components.

FIG. 7 is a perspective view illustrating a tray and related components provided in the water purifier of FIG. 1.

FIG. 8 is a plan view illustrating the tray and related components of FIG. 7.

FIG. 9 is an exploded perspective view illustrating the tray and related components of FIG. 7.

FIG. 10 is a perspective view illustrating the tray of FIG. 7.

FIG. 11 is a plan view illustrating the tray of FIG. 10.

FIG. 12 is a front view illustrating the tray of FIG. 10.

FIG. 13 is a front cross-sectional view taken along line C-C of FIG. 10, illustrating the tray.

FIG. 14 is a perspective view illustrating an evaporator of FIG. 7.

FIG. 15 is a plan view illustrating the evaporator of FIG. 14.

FIG. 16 is a perspective view illustrating a flow path member of FIG. 7.

FIG. 17 is an exploded perspective view illustrating the flow path member of FIG. 16.

FIG. 18 is a perspective view illustrating a flow path housing of the flow path member of FIG. 16.

FIG. 19 is a front view illustrating the flow path housing of FIG. 18.

FIG. 20 is a front cross-sectional view taken along line E-E of FIG. 18, illustrating the flow path housing.

FIG. 21 is a perspective view illustrating a cover member of the flow path member of FIG. 16.

FIG. 22 is a front view illustrating the cover member of FIG. 21.

FIG. 23 is a front cross-sectional view taken along line F-F of FIG. 21, illustrating the cover member.

FIG. 24 is a front cross-sectional view taken along line B-B of FIG. 7, illustrating the tray and related components.

FIG. 25 is a partial enlarged view of portion A of FIG. 24.

FIGS. 26 and 27 are block diagrams illustrating various flow paths formed inside the water purifier of FIG. 1.

FIG. 28 is a flowchart illustrating a control method of the water purifier according to an exemplary embodiment of the present disclosure.

FIG. 29 is a flowchart illustrating a detailed flow of step S100 of the control method of the water purifier of FIG. 28.

FIG. 30 is a flowchart illustrating a detailed flow of step S200 of the control method of the water purifier of FIG. 28.

FIG. 31 is a flowchart illustrating a detailed flow of step S300 of the control method of the water purifier of FIG. 28.

FIG. 32 is a flowchart illustrating a detailed flow of step S400 of the control method of the water purifier of FIG. 28.

FIG. 33 is a flowchart illustrating a detailed flow of step S500 of the control method of the water purifier of FIG. 28.

### DETAILED DESCRIPTION OF THE EMBODIMENTS

Hereinafter, exemplary embodiments of the present disclosure will be described in detail so that those of ordinary skill in the art can readily implement the present disclosure with reference to the accompanying drawings. The present disclosure may be embodied in many different forms and is not limited to the embodiments set forth herein. Portions irrelevant to the description have been omitted for clarity of explanation of the present disclosure, and throughout the specification, the same reference numerals are used to denote identical or similar components.

The words and terms used in the present specification and claims should not be interpreted as being limited to their ordinary or dictionary meanings, but should be construed as having meanings and concepts consistent with the technical spirit of the present disclosure, in accordance with the principle that an inventor may define terms and concepts to best describe their invention.

Accordingly, the embodiments described in the present specification and the configurations shown in the drawings correspond to preferred embodiments of the present disclosure, and do not represent all the technical spirit of the present disclosure, so the configurations may have various examples of equivalent and modification that can replace them at the time of filing the present disclosure.

In the following description, explanations of some components may be omitted to clarify the features of the present disclosure.

The term “fluid communication” used in the following description refers to a state in which one or more members are connected so as to allow fluid flow between them. In one embodiment, the fluid communication may be established by members such as conduits, pipes, or tubes. In the following description, the term “fluid communication” may be used to mean that one or more members are “fluidically connected” to each other.

In the following description, the term “electrical connection” refers to a state in which one or more members are connected so as to enable the transmission of electric current and/or electrical signals between them, and may encompass electrical conduction. In one embodiment, the electrical connection may be established in a wired form by a conductive wire member or the like, or in a wireless form such as Bluetooth, Wi-Fi, or RFID. In one embodiment, the electrical connection may include the meaning of “electrical communication.”

The term “fluid” used in the following description refers to any form of material that flows by external force and whose shape or volume can be changed. In one embodiment, the fluid may be a liquid such as water or a gas such as air.

In the following description, the terms “upper side or above,” “lower side or below,” “left side,” “right side,” “front side,” and “rear side” will be understood with reference to the coordinate system shown throughout the accompanying drawings.

### 1. Description of Water Purifier 10 According to an Embodiment of the Present Disclosure

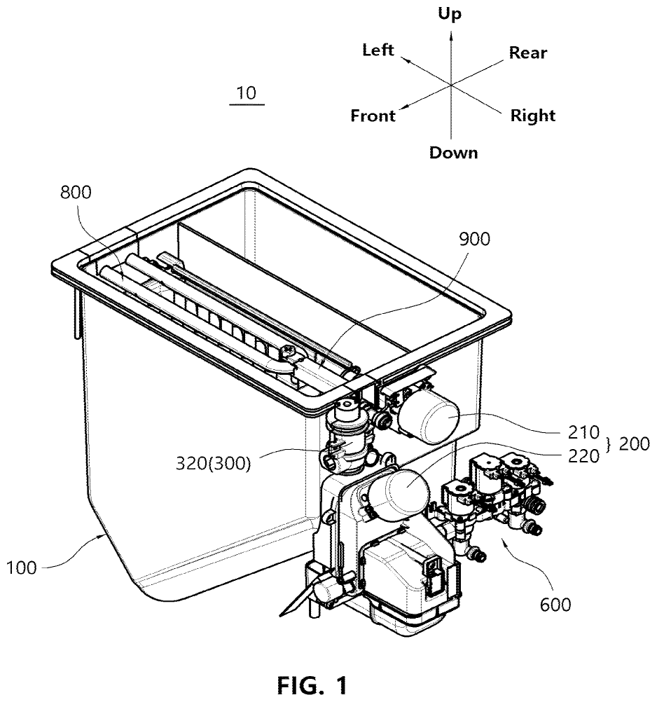

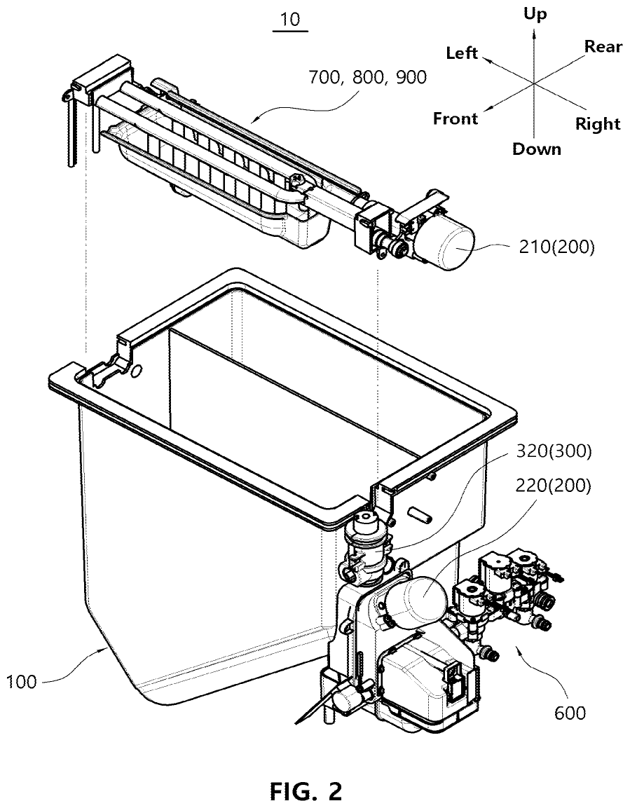

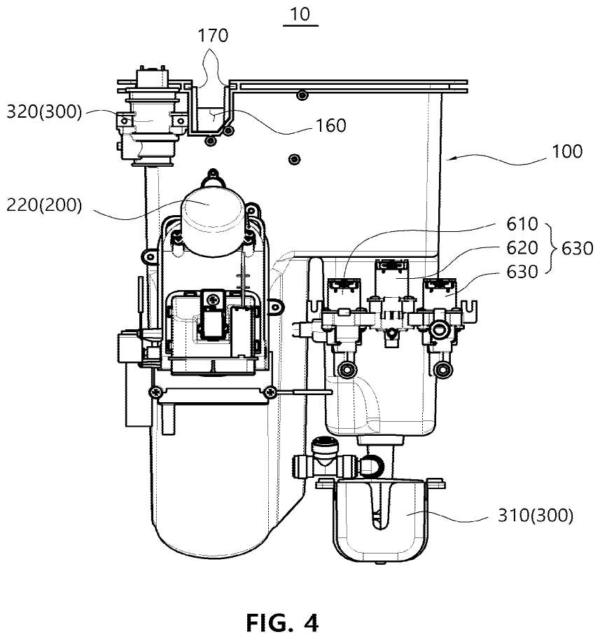

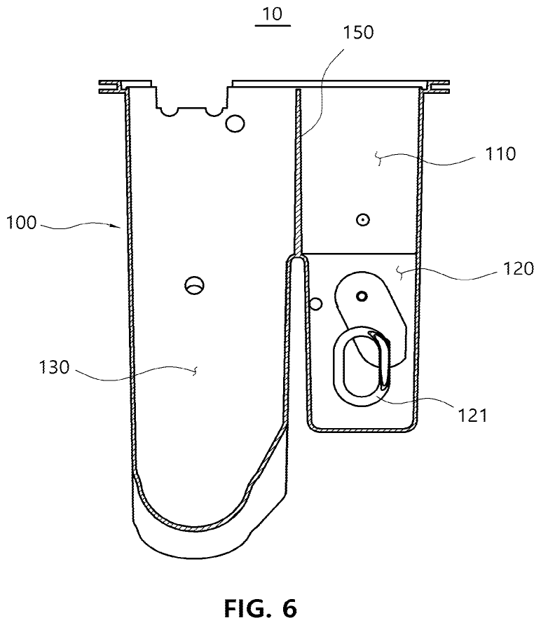

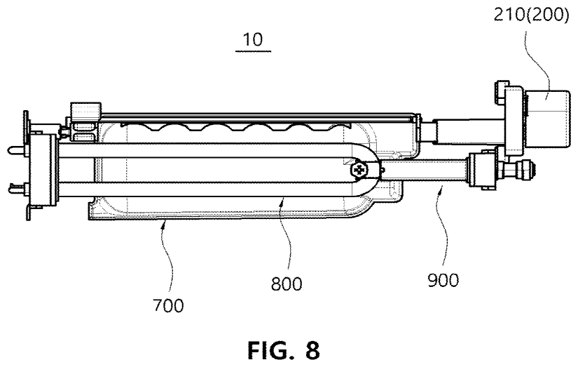

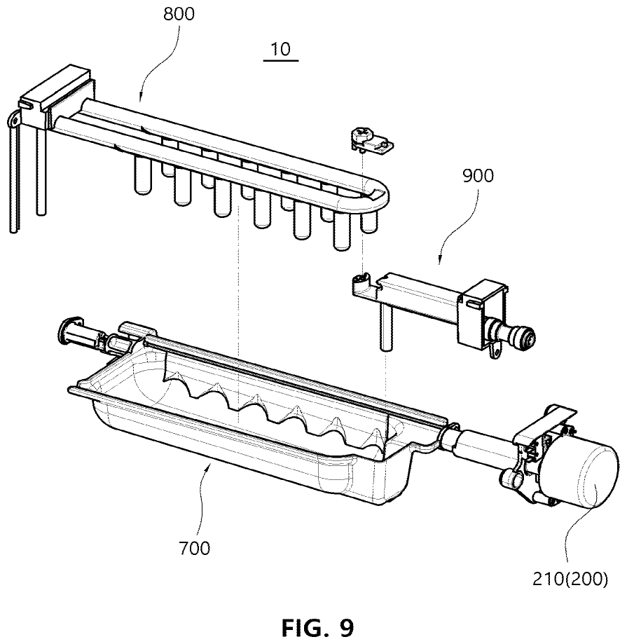

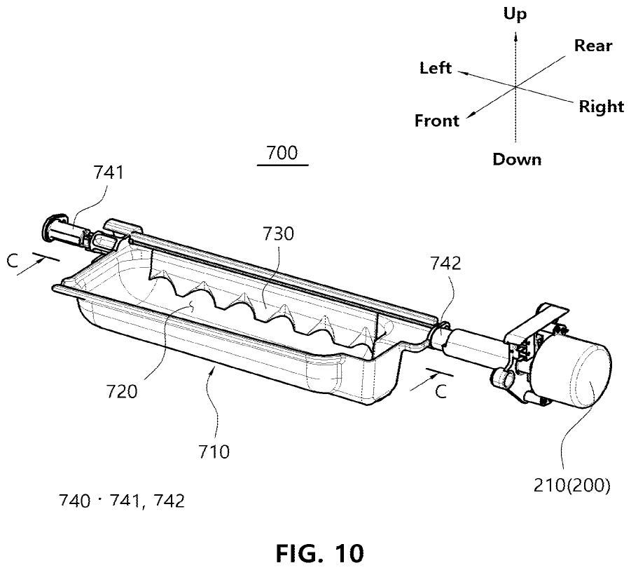

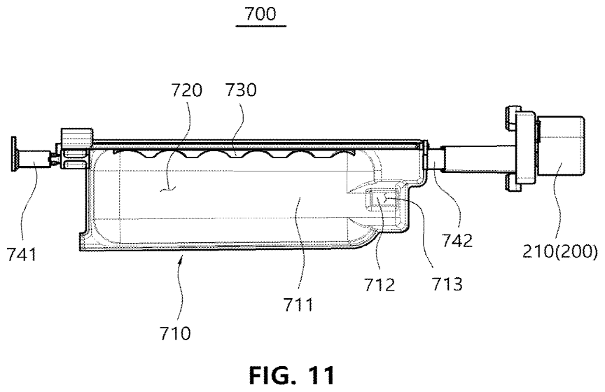

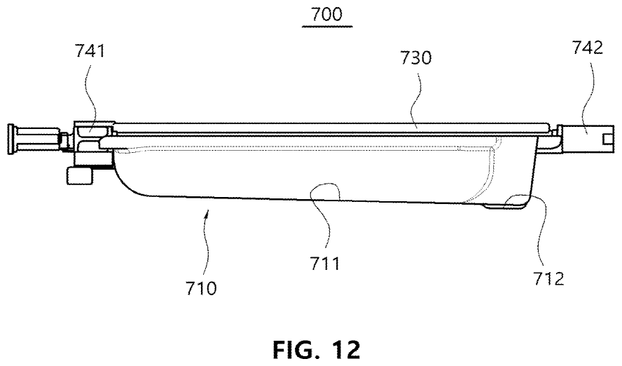

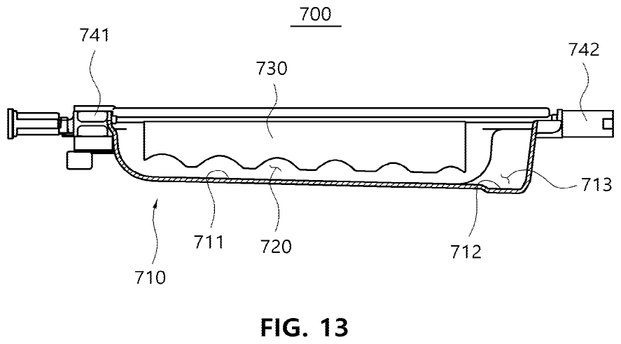

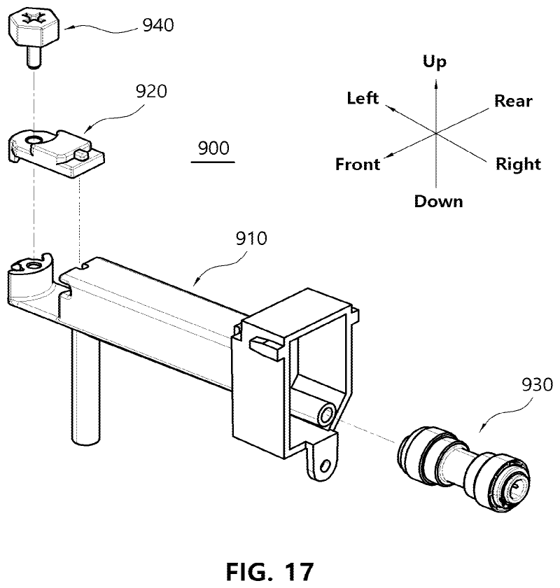

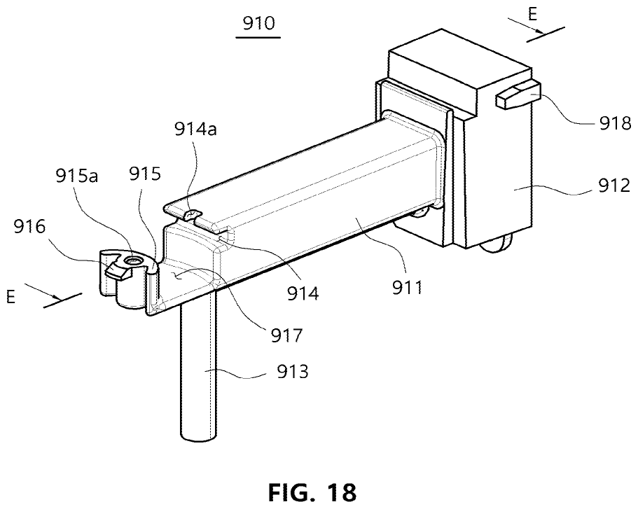

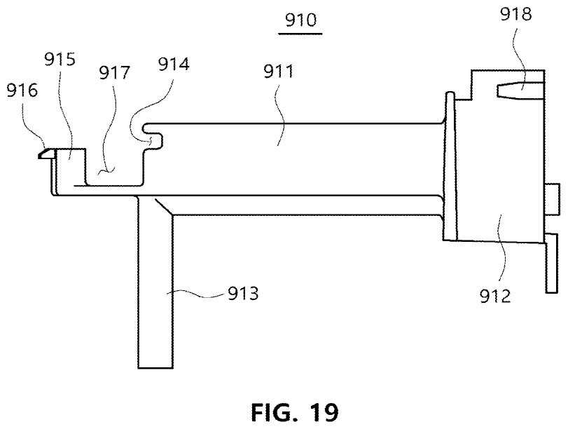

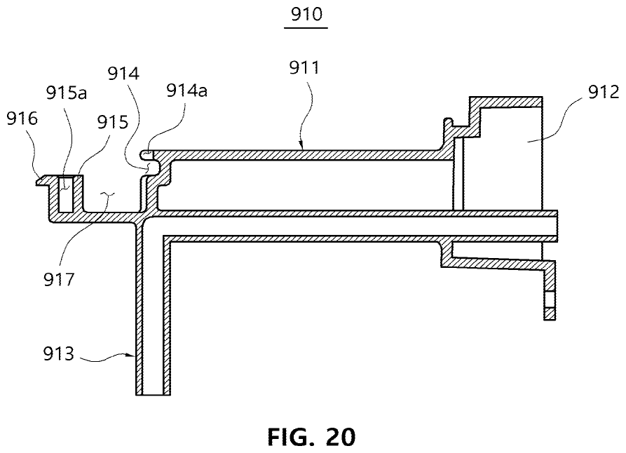

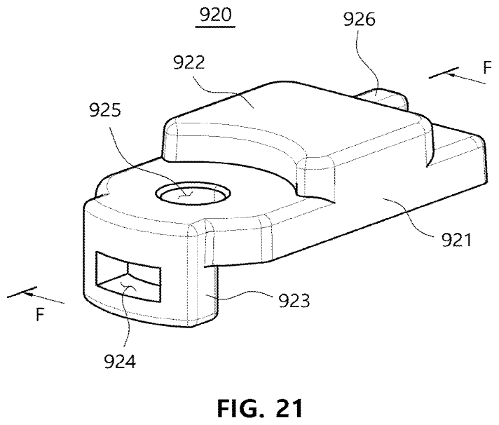

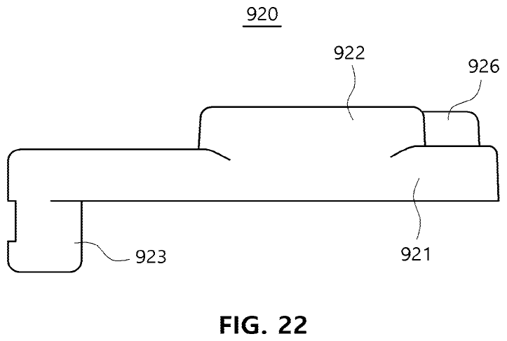

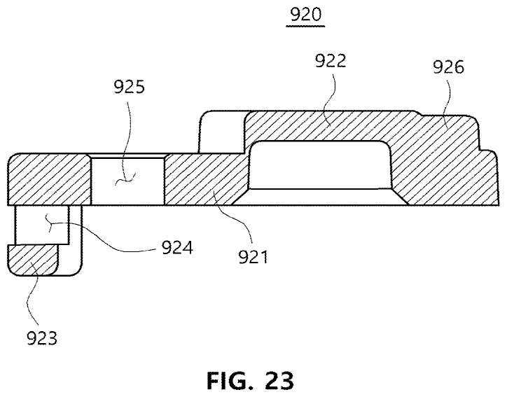

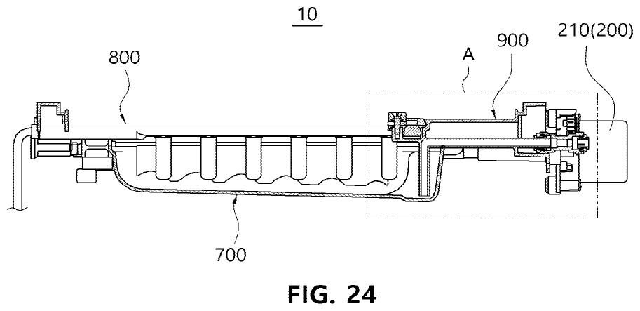

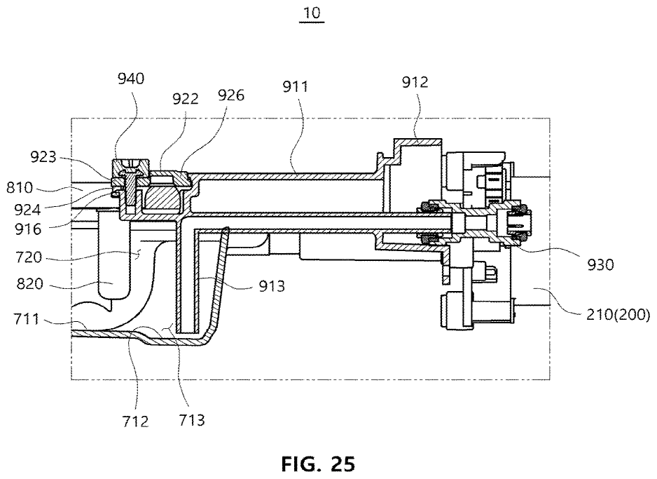

Referring to FIGS. 1 to 27, a configuration of a water purifier 10 according to an embodiment of the present disclosure is illustrated by way of example.

The water purifier 10 according to an embodiment of the present disclosure may receive source water from an external source, filter the source water, and generate purified water. The water purifier 10 may cool the generated purified water to generate cold water or heat the generated purified water to generate hot water.

In addition, the water purifier 10 may generate ice using the generated purified water or cold water. In this case, the water purifier 10 may recover a fluid remaining after ice making, that is, residual water, and reuse the residual water as purified water or cold water.

Furthermore, after the residual water is recovered, the water purifier 10 may sterilize components for accommodating purified water or cold water using hot water before purified water or cold water is provided again for ice making.

Accordingly, in the water purifier 10 according to an embodiment of the present disclosure, generation of purified water or cold water in an amount corresponding to the recovered residual water is unnecessary. Accordingly, usage of components for generating purified water, that is, filters, is reduced, and a service life thereof may be increased.

In addition, usage of components for generating cold water, that is, a cold water tank 120 to be described later, is reduced, and a service life thereof may be increased. At the same time, power required for operation of the cold water tank 120 is reduced, thereby improving overall energy efficiency of the water purifier 10.

In the embodiment illustrated in FIGS. 1, 2, and 26, the water purifier 10 includes a tank unit 100, a power unit 200, a pump unit 300, a flow path unit 400, a valve unit 500, a discharge unit 600, a tray 700, an evaporator 800, and a flow path member 900.

The tank unit 100 constitutes a portion of an outer appearance of the water purifier 10. An internal space may be formed in the tank unit 100 to store generated purified water and cold water. In addition, the internal space of the tank unit 100 may be physically partitioned. Among a plurality of physically partitioned spaces, one space may accommodate components for ice making, that is, the tray 700, the evaporator 800, and the flow path member 900.

The tank unit 100 is coupled to the power unit 200. Some components accommodated in the tank unit 100 may be rotated by the power unit 200. In one embodiment, the power unit 200 may be coupled through the tank unit 100.

The tank unit 100 is coupled to and supports the pump unit 300. Cold water or purified water accommodated in the tank unit 100 may flow to the discharge unit 600 by the pump unit 300. In addition, residual water accommodated in the tank unit 100 may be recovered by the pump unit 300. A detailed description thereof will be provided later.

The tank unit 100 is positioned adjacent to the discharge unit 600. Purified water, cold water, and hot water accommodated in the tank unit 100 may be provided to the outside through the discharge unit 600. The tank unit 100 may be connected to the discharge unit 600 by the flow path unit 400.

The tank unit 100 rotatably accommodates the tray 700. The tray 700 accommodated in the tank unit 100 may receive and accommodate purified water or cold water. The tank unit 100 accommodates the evaporator 800. The evaporator 800 may be at least partially immersed in purified water or cold water accommodated in the tray 700.

The tank unit 100 is coupled to the flow path member 900. At this time, the tank unit 100 may accommodate at least a portion of the flow path member 900. The flow path member 900 may be positioned adjacent to the tray 700 while being coupled to and supported by the tank unit 100.

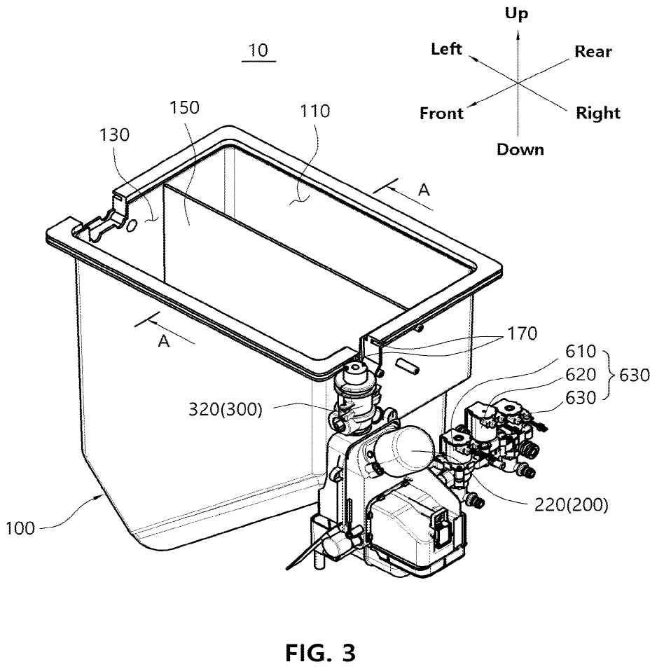

In the embodiment illustrated in FIGS. 3 to 6, 26, and 27, the tank unit 100 includes a purified water tank 110, a cold water tank 120, an ice tank 130, a hot water tank 140, a partition member 150, a flow path member accommodating groove 160, and a flow path member coupling groove 170.

The purified water tank 110 constitutes one space formed inside the tank unit 100. The purified water tank 110 may be defined as being at least partially surrounded by an inner surface of the tank unit 100 and the partition member 150. The purified water tank 110 stores purified water generated by passing through a filter (not shown). The purified water tank 110 is connected to the filter (not shown).

In the illustrated embodiment, each side in the longitudinal direction and one side in the width direction—namely, left, right, and rear sides—of the purified water tank 110 are surrounded by the inner surface of the tank unit 100. The other side in the width direction—namely, a front side—of the purified water tank 110 is surrounded by the partition member 150. Each side in the height direction—namely, an upper side and a lower side—of the purified water tank 110 is open.

The purified water tank 110 is positioned adjacent to the cold water tank 120. In the illustrated embodiment, the purified water tank 110 may be positioned above the cold water tank 120. Cold water generated in the cold water tank 120 may not rise into the purified water tank 110 due to a temperature difference.

In the illustrated embodiment, the purified water tank 110 and the cold water tank 120 are open to each other and are in fluid communication. Alternatively, the purified water tank 110 and the cold water tank 120 may be connected through a separate flow path.

The purified water tank 110 is physically partitioned from the ice tank 130 by the partition member 150. Purified water accommodated in the purified water tank 110 is restricted from flowing into the ice tank 130. Ice generated in the ice tank 130 may also be restricted from flowing into the purified water tank 110.

The cold water tank 120 constitutes another space formed inside the tank unit 100. The cold water tank 120 may be defined as being at least partially surrounded by the inner surface of the tank unit 100 and the partition member 150. The cold water tank 120 receives purified water that has flowed downward through the purified water tank 110, generates cold water, and stores the generated cold water. The cold water tank 120 is in fluid communication with the purified water tank 110.

In the illustrated embodiment, each side in the longitudinal direction, one side in the width direction, and one side in the height direction—namely, left, right, rear, and lower sides—of the cold water tank 120 are surrounded by the inner surface of the tank unit 100. The other side in the width direction—namely, a front side—of the cold water tank 120 is surrounded by the partition member 150. The other side in the height direction—namely, an upper side—of the purified water tank 110 is open.

The cold water tank 120 is positioned adjacent to the purified water tank 110. In the illustrated embodiment, the cold water tank 120 is positioned below the purified water tank 110 to receive and cool purified water flowing from the purified water tank 110.

The cold water tank 120 may be configured in any form capable of cooling and storing purified water. In the illustrated embodiment, the cold water tank 120 includes a cooling device 121 and a baffle member 122.

The cooling device 121 is connected to and controlled by an external controller C. The cooling device 121 may be accommodated in the cold water tank 120 and configured to cool purified water accommodated in the cold water tank 120.

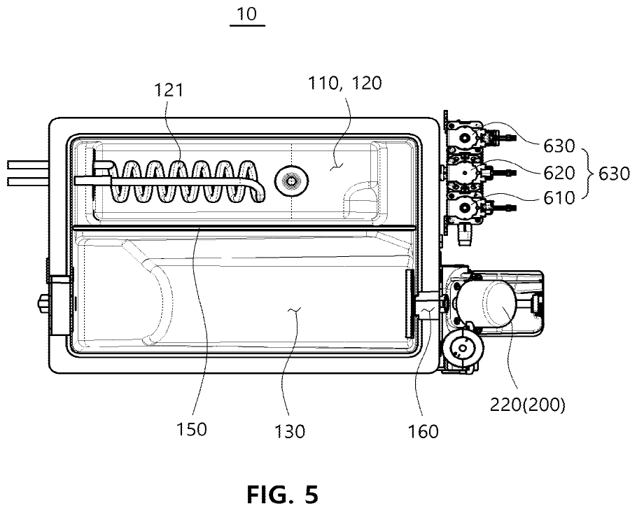

The cooling device 121 may be provided in any form capable of generating cold water by cooling purified water accommodated in the cold water tank 120. In the embodiment illustrated in FIG. 5, the cooling device 121 is provided as a refrigerant pipe extending in a left-right direction and having a helical shape.

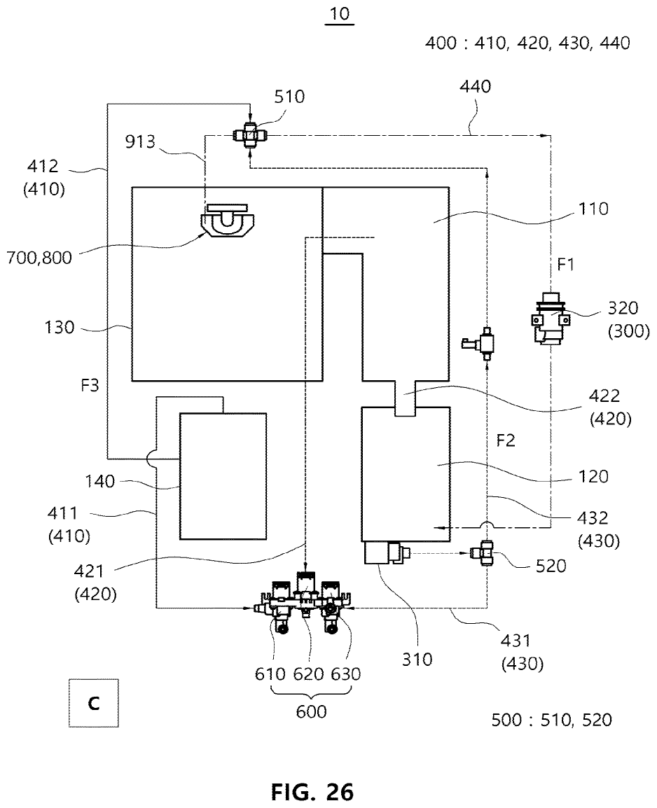

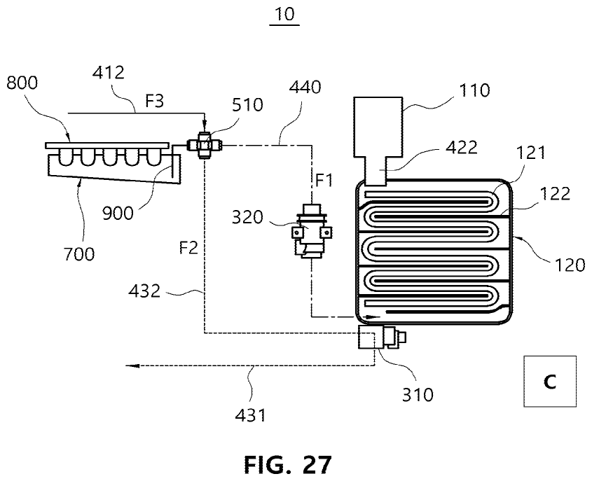

In addition, in the embodiment illustrated in FIGS. 26 and 27, the cooling device 121 is provided as a refrigerant pipe extending in a zigzag manner through a plurality of spaces partitioned by the baffle member 122.

The baffle member 122 partitions an internal space of the cold water tank 120 into a plurality of small spaces that are in fluid communication with each other in a zigzag manner (see FIGS. 26 and 27). The baffle member 122 may be provided as a plurality of plate-shaped members extending from the inner surface of the cold water tank 120.

In the illustrated embodiment, the plurality of plate-shaped members are spaced apart in the height direction of the cold water tank 120 and alternately connected to respective sides in the width direction of the cold water tank 120. Accordingly, the internal space of the cold water tank 120 may extend in a zigzag manner.

In this embodiment, a recovery flow path 440 may be connected to the cold water tank 120 at a position adjacent to one of the plurality of small spaces.

The baffle member 122 may be optionally provided. That is, as illustrated in FIG. 5, the cold water tank 120 may be configured without the baffle member 122. Alternatively, as illustrated in FIGS. 26 and 27, the cold water tank 120 may be configured to include the baffle member 122.

In any case, it is sufficient as long as the cold water tank 120 is capable of cooling accommodated purified water to generate cold water.

The ice tank 130 constitutes a remaining space formed inside the tank unit 100. The ice tank 130 may be defined as being at least partially surrounded by the inner surface of the tank unit 100 and the partition member 150. The ice tank 130 rotatably accommodates the tray 700 and accommodates the evaporator 800.

Furthermore, the ice tank 130 may at least partially accommodate the flow path member 900. The ice tank 130 stores ice generated by the evaporator 800.

In the illustrated embodiment, each side in the longitudinal direction, one side in the width direction, and one side in the height direction—namely, left, right, front, and lower sides—of the ice tank 130 are surrounded by the inner surface of the tank unit 100. The other side in the width direction—namely, a rear side—of the ice tank 130 is surrounded by the partition member 150. The other side in the height direction—namely, an upper side—of the ice tank 130 is open.

The ice tank 130 is positioned adjacent to the purified water tank 110 and the cold water tank 120. The ice tank 130 may receive purified water accommodated in the purified water tank 110 or cold water accommodated in the cold water tank 120. In this case, it will be understood that the provided purified water or cold water is accommodated in the tray 700. The ice tank 130 is connected to the purified water tank 110 and the cold water tank 120 by the flow path unit 400.

The ice tank 130 may accommodate a component for providing accommodated ice to the outside, for example, a screw member (not shown). The screw member (not shown) is positioned below the ice tank 130 and may be coupled to a screw motor 220. When the screw member (not shown) is operated by the screw motor 220, ice may be moved and provided to the outside.

The hot water tank 140 receives purified water and heats the purified water to generate hot water. The hot water tank 140 may accommodate the generated hot water. The hot water tank 140 may provide the accommodated hot water to the outside or to the tray 700. The hot water tank 140 is connected to the outside by the flow path unit 400. In addition, the hot water tank 140 is connected to the tray 700 by the flow path unit 400 and the flow path member 900.

In particular, the hot water tank 140 according to an embodiment of the present disclosure is configured to provide generated hot water to the tray 700 for sterilization purposes. Accordingly, after residual water is recovered, the tray 700 is sterilized, thereby improving hygiene of newly produced ice.

The partition member 150 partitions a space formed inside the tank unit 100 into a plurality of spaces. Each space partitioned by the partition member 150 is isolated from fluid communication with the others. The partition member 150 partially surrounds each of the partitioned spaces.

In the illustrated embodiment, the partition member 150 is provided in a plate shape having a length in the left-right direction, a height in the up-down direction, and a thickness in the front-rear direction. The partition member 150 partitions the ice tank 130 from the purified water tank 110 and the cold water tank 120 in the front-rear direction.

The flow path member accommodating groove 160 is one portion where the tank unit 100 is coupled to the flow path member 900. The flow path member accommodating groove 160 may be recessed in an outer circumferential surface of the tank unit 100 to accommodate a portion of the flow path member 900. The flow path member accommodating groove 160 allows fluid communication between the partition member 150 and the outside of the tank unit 100 in the longitudinal direction of the tank unit 100, which is the left-right direction in the illustrated embodiment.

In the illustrated embodiment, the flow path member accommodating groove 160 is recessed at an upper front-right corner of the outer circumferential surface of the tank unit 100. A flow path housing 910 may be partially inserted into the flow path member accommodating groove 160.

The flow path member accommodating groove 160 may have any shape capable of partially accommodating the flow path housing 910. In the illustrated embodiment, the flow path member accommodating groove 160 is formed as a polygonal pillar-shaped space having a polygonal cross-section and a height in the left-right direction.

The flow path member coupling groove 170 is another portion where the tank unit 100 is coupled to the flow path member 900. The flow path member coupling groove 170 may be recessed in an inner circumferential surface of the tank unit 100—specifically, an inner circumferential surface surrounding the flow path member accommodating groove 160—to accommodate another portion of the flow path member 900. The flow path member coupling groove 170 allows fluid communication between the partition member 150 and the outside of the tank unit 100 in the longitudinal direction of the tank unit 100, which is the left-right direction in the illustrated embodiment.

In the illustrated embodiment, the flow path member coupling groove 170 is formed at a right edge of the tank unit 100. The flow path member coupling groove 170 is recessed in inner circumferential surfaces of the tank unit 100 that surround the flow path member accommodating groove 160 in the width direction—namely, a front inner circumferential surface and a rear inner circumferential surface in the illustrated embodiment.

The flow path member coupling groove 170 extends in the extension direction of the flow path member accommodating groove 160, which is the left-right direction in the illustrated embodiment. A cover coupling protrusion 916 may be inserted into the flow path member coupling groove 170.

The flow path member coupling groove 170 may be provided as a pair. The pair of flow path member coupling grooves 170 are spaced apart in the front-rear direction to respectively accommodate a pair of tank coupling protrusions 918.

The power unit 200 is configured to provide power for operation of some components of the water purifier 10. The power unit 200 is electrically connected to the components described above and to the controller C.

The power unit 200 is coupled to the tank unit 100. Specifically, the power unit 200 may be directly or indirectly coupled to and supported by the tank unit 100. In the illustrated embodiment, the power unit 200 may be coupled to and supported by one side in the longitudinal direction of the tank unit 100, namely, a right-side portion thereof.

The power unit 200 may be provided in any form capable of operating the components of the water purifier 10. In one embodiment, the power unit 200 may be provided in the form of an electric motor.

In the illustrated embodiment, the power unit 200 includes a tray motor 210 and a screw motor 220.

The tray motor 210 rotates the tray 700. The tray motor 210 may be coupled to and supported by the tank unit 100 and may apply rotational force by being coupled to a second tray support member 742. The tray 700 may be rotated clockwise or counterclockwise by the tray motor 210. One of the tray motor 210 and the second tray support member 742 may be rotatably penetratively coupled to the tank unit 100.

The tray motor 210 is positioned outside the tank unit 100. Accordingly, the tray motor 210 may not affect fluid or ice accommodated inside the tank unit 100.

The screw motor 220 rotates a screw member (not shown) accommodated in the ice tank 130. The screw motor 220 may be coupled to and supported by the tank unit 100 and may apply rotational force by being coupled to the screw member (not shown).

The screw member (not shown) may be rotated clockwise or counterclockwise by the screw motor 220. One of the screw motor 220 and the screw member (not shown) may be rotatably coupled to the tank unit 100.

The screw motor 220 is also positioned outside the tank unit 100. Accordingly, the screw motor 220 may not affect fluid or ice accommodated inside the tank unit 100.

The pump unit 300 provides a transfer force to fluid residing inside the water purifier 10. Fluid accommodated in one component of the water purifier 10 may flow to another component by the transfer force applied by the pump unit 300.

The pump unit 300 is coupled to the flow path unit 400. The pump unit 300 may be in fluid communication with the flow path unit 400 and may apply a transfer force to fluid accommodated in another component connected to the flow path unit 400.

The pump unit 300 is electrically connected to the controller C. The pump unit 300 may be controlled by the controller C.

The pump unit 300 may be provided in plurality. The plurality of pump units 300 may be disposed at different positions and connected to different components of the flow path unit 400.

In the illustrated embodiment, the pump unit 300 includes a cold water pump 310 and a recovery pump 320.

The cold water pump 310 provides a transfer force such that cold water accommodated in the cold water tank 120 flows to a cold water discharge member 630 or the flow path member 900. The cold water pump 310 is connected to the cold water tank 120 and a cold water valve 520, respectively. As best illustrated in FIG. 26, the cold water pump 310 is positioned between the cold water tank 120 and the cold water valve 520.

In one embodiment, the cold water pump 310 may be positioned below the cold water tank 120. In this embodiment, cold water accommodated in the cold water tank 120 may flow not only by the transfer force applied by the cold water pump 310 but also by gravity. Accordingly, power required for cold water flow may be reduced, thereby improving power efficiency of the water purifier 10.

The recovery pump 320 provides a transfer force such that residual water accommodated in the tray 700 flows to the cold water tank 120. The recovery pump 320 may be disposed on a recovery flow path 440 and be in fluid communication with the recovery flow path 440. In this case, the recovery pump 320 may be positioned adjacent to the flow path member 900.

In the embodiment illustrated in FIGS. 3 to 5, the recovery pump 320 is positioned on a right side of the tank unit 100 so as to be adjacent to the flow path member accommodating groove 160 and the flow path member coupling groove 170.

The flow path unit 400 fluidically connects respective components of the water purifier 10. Fluid accommodated in one component of the water purifier 10 may be delivered to another component through the flow path unit 400. Accordingly, the flow path unit 400 may be regarded as defining a flow path of a fluid staying inside the water purifier 10.

The flow path unit 400 is connected to the tank unit 100. Specifically, the flow path unit 400 is connected to the purified water tank 110, the cold water tank 120, and the hot water tank 140. Purified water, cold water, and hot water may flow into or out of the purified water tank 110, the cold water tank 120, and the hot water tank 140 through the flow path unit 400.

The flow path unit 400 is connected to the pump unit 300. A transfer force required for fluid flow may be provided by the pump unit 300.

The flow path unit 400 is connected to the valve unit 500. As will be described later, the flow path unit 400 may include a plurality of components, and respective components of the flow path unit 400 may be connected to each other through the valve unit 500. In addition, respective components of the flow path unit 400 may be connected to other components of the water purifier 10 through the valve unit 500.

The flow path unit 400 is connected to the discharge unit 600. Purified water, cold water, or hot water accommodated in the purified water tank 110, the cold water tank 120, and the hot water tank 140 may be provided to the outside through the discharge unit 600 via the flow path unit 400.

The flow path unit 400 is connected to the flow path member 900. The flow path unit 400 may be connected to the flow path member 900 by the valve unit 500. Accordingly, residual water remaining in the tray 700 may be recovered to the cold water tank 120 through the flow path member 900 and the flow path unit 400. In addition, purified water or cold water accommodated in the purified water tank 110 or the cold water tank 120 may be provided to the tray 700 through the flow path unit 400 and the flow path member 900.

Furthermore, hot water accommodated in the hot water tank 140 may be provided to the tray 700 through the flow path unit 400 and the flow path member 900.

The flow path unit 400 may be provided in any form capable of defining a fluid flow path. For example, the flow path unit 400 may be provided in the form of a pipe or a tube.

In the embodiment illustrated in FIGS. 26 to 27, the flow path unit 400 includes a hot water flow path 410, a purified water flow path 420, a cold water flow path 430, and a recovery flow path 440.

The hot water flow path 410 fluidically connects the hot water tank 140 to other components of the water purifier 10. Hot water accommodated in the hot water tank 140 may be delivered to other components of the water purifier 10 through the hot water flow path 410.

In the illustrated embodiment, the hot water flow path 410 includes a hot water discharge flow path 411 and a hot water supply flow path 412.

The hot water discharge flow path 411 connects the hot water tank 140 to a hot water discharge member 610. Hot water accommodated in the hot water tank 140 may flow along the hot water discharge flow path 411 and be provided to the outside through the hot water discharge member 610.

The hot water supply flow path 412 connects the hot water tank 140 to the flow path member 900. Specifically, the hot water tank 140 may be connected to the flow path member 900 through the hot water supply flow path 412 and a multi-valve 510. Hot water accommodated in the hot water tank 140 may be provided to the tray 700 through the flow path member 900 after sequentially passing through the hot water supply flow path 412 and the multi-valve 510.

As will be described later, the flow path member 900 is disposed to be in fluid communication with the tray space 720, and thus hot water flowing along the hot water supply flow path 412 may be provided to the tray space 720 and utilized to sterilize an inner circumferential surface of the tray body 710.

The purified water flow path 420 fluidically connects the purified water tank 110 to other components of the water purifier 10. Purified water accommodated in the purified water tank 110 may be delivered to other components of the water purifier 10 through the purified water flow path 420.

In the illustrated embodiment, the purified water flow path 420 includes a purified water discharge flow path 421 and a purified water supply flow path 422.

The purified water discharge flow path 421 connects the purified water tank 110 to a purified water discharge member 620. Purified water accommodated in the purified water tank 110 may flow along the purified water discharge flow path 421 and be provided to the outside through the purified water discharge member 620.

The purified water supply flow path 422 connects the purified water tank 110 to the cold water tank 120. Purified water accommodated in the purified water tank 110 may flow along the purified water supply flow path 422 and be provided to the cold water tank 120.

In one embodiment, the purified water supply flow path 422 may not be provided. That is, as illustrated in FIGS. 3 to 6, in an embodiment in which the purified water tank 110 and the cold water tank 120 are integrally provided, the purified water supply flow path 422 may not be separately provided.

Although not illustrated, a separate flow path connecting the purified water tank 110 to the multi-valve 510 may be provided. In this embodiment, purified water accommodated in the purified water tank 110 may be directly provided to the tray 700 through the flow path member 900 after sequentially passing through the separate flow path and the multi-valve 510.

The cold water flow path 430 fluidically connects the cold water tank 120 to other components of the water purifier 10. Cold water accommodated in the cold water tank 120 may be delivered to other components of the water purifier 10 through the cold water flow path 430.

In the illustrated embodiment, the cold water flow path 430 includes a cold water discharge flow path 431 and a cold water supply flow path 432.

The cold water discharge flow path 431 connects the cold water tank 120 to the cold water discharge member 630. Cold water accommodated in the cold water tank 120 may flow along the cold water discharge flow path 431 and be provided to the outside through the cold water discharge member 630. The cold water discharge flow path 431 is connected to the cold water valve 520. Cold water discharged from the cold water tank 120 may be branched by the cold water valve 520 and flow toward the multi-valve 510 or the cold water discharge member 630.

The cold water supply flow path 432 connects the cold water tank 120 to the flow path member 900. Specifically, the cold water tank 120 may be connected to the flow path member 900 through the cold water supply flow path 432 and the multi-valve 510. Cold water accommodated in the cold water tank 120 may be provided to the tray 700 through the flow path member 900 after sequentially passing through the cold water supply flow path 432 and the multi-valve 510.

The recovery flow path 440 fluidically connects the flow path member 900 to the cold water tank 120. The recovery flow path 440 defines a flow path through which residual water staying in the tray space 720 is recovered to the cold water tank 120. The recovery flow path 440 is formed as a flow path separate from the cold water flow path 430, specifically the cold water supply flow path 432.

The recovery flow path 440 is connected to the recovery pump 320. Residual water accommodated in the tray space 720 may flow along the recovery flow path 440 and be recovered to the cold water tank 120 after sequentially passing through the flow path member 900 and the multi-valve 510 by a transfer force applied by the recovery pump 320.

In this case, the recovery flow path 440 may be connected to the cold water tank 120 at any position. That is, in the embodiment illustrated in FIG. 27, the recovery flow path 440 is connected to the cold water tank 120 at a position adjacent to a lower side of the cold water tank 120. Alternatively, the recovery flow path 440 may be connected to the cold water tank 120 at any position along the height direction of the cold water tank 120.

In any case, it is sufficient as long as residual water flowing along the recovery flow path 440 can be provided again to the cold water tank 120.

The valve unit 500 fluidically connects respective components of the water purifier 10 or respective components of the flow path unit 400. Fluid accommodated in respective components of the water purifier 10 may flow to other components by the flow path unit 400 and the valve unit 500 coupled thereto.

The valve unit 500 may be provided in plurality. The plurality of valve units 500 may be connected to different components of the water purifier 10 or respective components of the flow path unit 400 at different positions.

In the illustrated embodiment, the valve unit 500 includes the multi-valve 510 and the cold water valve 520.

The multi-valve 510 connects the hot water flow path 410, the cold water flow path 430, the recovery flow path 440, and the flow path member 900. Accordingly, the multi-valve 510 may be regarded as fluidically connecting the cold water tank 120, the hot water tank 140, and the flow path member 900 to each other.

Specifically, the multi-valve 510 is connected to the hot water supply flow path 412. Hot water accommodated in the hot water tank 140 may flow along the hot water supply flow path 412 and be provided to the multi-valve 510.

In addition, the multi-valve 510 is connected to the cold water discharge flow path 431. Cold water accommodated in the cold water tank 120 may flow along the cold water discharge flow path 431 and be provided to the multi-valve 510.

Furthermore, the multi-valve 510 is connected to the recovery flow path 440. Residual water recovered by the flow path member 900 may flow along the recovery flow path 440 and be recovered to the cold water tank 120.

In addition, the multi-valve 510 is connected to the flow path member 900, specifically a pipe part 913. Cold water or hot water provided to the multi-valve 510 may be provided to the tray space 720 through the pipe part 913. In addition, residual water recovered from the tray space 720 through the pipe part 913 may be provided to the recovery flow path 440 through the multi-valve 510.

The multi-valve 510 may be provided in any form capable of connecting the hot water flow path 410, the cold water flow path 430, the recovery flow path 440, and the flow path member 900, respectively. In one embodiment, the multi-valve 510 may be provided as a 4-way valve.

The cold water valve 520 branches a flow path of cold water discharged from the cold water tank 120. The cold water valve 520 is connected to the cold water pump 310 and the cold water discharge flow path 431, respectively. Cold water discharged from the cold water tank 120 may flow to either the multi-valve 510 or the cold water discharge member 630 through the cold water valve 520.

The cold water valve 520 may be provided in any form capable of branching a flow of cold water. In one embodiment, the cold water valve 520 may be provided as a 3-way valve.

The discharge unit 600 is configured to provide purified water, cold water, and hot water accommodated in the purified water tank 110, the cold water tank 120, and the hot water tank 140 to the outside. The discharge unit 600 may be connected to the purified water tank 110, the cold water tank 120, and the hot water tank 140 through the flow path unit 400.

The discharge unit 600 may be provided in any form capable of discharging purified water, cold water, and hot water by operation according to a user input or an arbitrary control signal.

The discharge unit 600 may be provided in plurality. The plurality of discharge units 600 may be connected to the purified water tank 110, the cold water tank 120, and the hot water tank 140 through different components of the flow path unit 400, respectively.

In the illustrated embodiment, the discharge unit 600 includes a hot water discharge member 610, a purified water discharge member 620, and a cold water discharge member 630.

The hot water discharge member 610 is connected to the hot water tank 140 through the hot water discharge flow path 411. Hot water accommodated in the hot water tank 140 may flow along the hot water discharge flow path 411 and be provided to the outside by operation of the hot water discharge member 610.

The purified water discharge member 620 is connected to the purified water tank 110 through the purified water discharge flow path 421. Purified water accommodated in the purified water tank 110 may flow along the purified water discharge flow path 421 and be provided to the outside by operation of the purified water discharge member 620.

The cold water discharge member 630 is connected to the cold water tank 120 through the cold water discharge flow path 431. Cold water accommodated in the cold water tank 120 may flow along the cold water discharge flow path 431 and be provided to the outside by operation of the cold water discharge member 630.

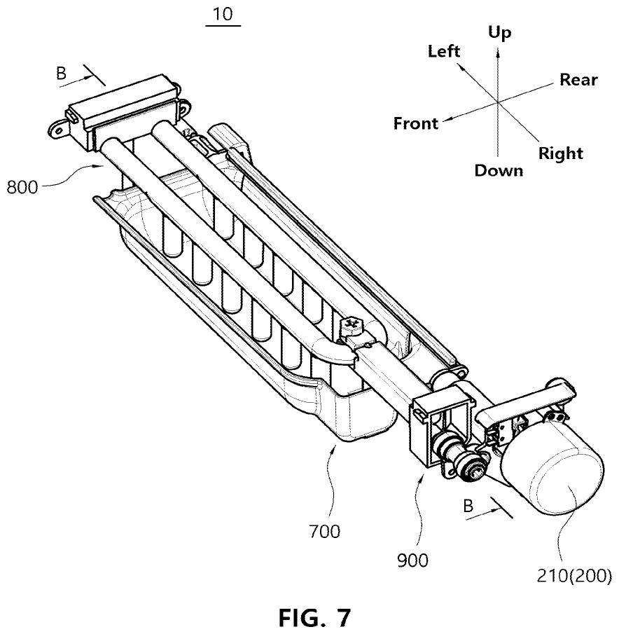

Referring to FIGS. 7 to 13, the water purifier 10 according to an embodiment of the present disclosure includes a tray 700.

The tray 700 receives and accommodates a fluid to be frozen, that is, ice-making water. The tray 700 accommodates, at least partially, an evaporator 800 through which a refrigerant flows. The ice-making water may be frozen around a portion of the evaporator 800 accommodated in the tray 700.

The tray 700 is coupled to the tank unit 100. The tray 700 is rotatably supported by the tank unit 100. The tray 700 is accommodated in the ice tank 130. In this case, the tray 700 is positioned on one side in the height direction of the ice tank 130, specifically, on an upper side in the illustrated embodiment.

The tray 700 is coupled to the power unit 200. Specifically, the tray 700 may be coupled to the tray motor 210 and be rotated by power applied by the tray motor 210. The tray 700 may be rotated between a first position located below the evaporator 800 and a second position located on a front side or a rear side of the evaporator 800.

At the first position, the tray 700 may be positioned between a bottom surface of the ice tank 130 and the evaporator 800. In this state, the evaporator 800 may be at least partially immersed in the ice-making water accommodated in the tray 700. The refrigerant flowing through the evaporator 800 cools the ice-making water, whereby ice making may be performed.

At the second position, the tray 700 may be positioned on one side in the width direction of the evaporator 800, that is, on a front side or a rear side thereof. In this state, the evaporator 800 may be disposed to directly face the bottom surface of the ice tank 130. When a fluid for ice release, for example hot gas, is provided to and flows through the evaporator 800 in this state, ice coupled to the evaporator 800, that is, the ice that has been formed, may be released and fall downward into the ice tank 130.

The tray 700 is positioned adjacent to the evaporator 800. A portion of the evaporator 800, specifically a finger member 820 to be described later, is accommodated at least partially in the tray 700. The refrigerant flowing through the evaporator 800 exchanges heat with the ice-making water accommodated in the tray 700, whereby ice making may be performed.

The tray 700 is positioned adjacent to the flow path member 900. The tray 700 accommodates, at least partially, a portion of the flow path member 900, specifically a pipe part 913 to be described later. Accordingly, purified water or cold water for ice making and hot water for sterilization may be supplied to the tray 700. In addition, residual water remaining in the tray 700 may be recovered to the cold water tank 120 through the pipe part 913.

In the illustrated embodiment, the tray 700 includes a tray body 710, a tray space 720, a flow-forming member 730, and tray support members 740.

The tray body 710 defines an outer shape of the tray 700. The tray body 710 is rotatably accommodated in the ice tank 130. In this case, the tray body 710 may be disposed to be spaced apart from other components of the tank unit 100 surrounding the ice tank 130.

A tray space 720 is formed inside the tray body 710. The tray body 710 surrounds the tray space 720 from a plurality of directions. In the illustrated embodiment, the tray body 710 is configured to surround the tray space 720 except for an upper side thereof.

The tray body 710 is positioned adjacent to the flow-forming member 730. The tray body 710 rotatably supports the flow-forming member 730. In the illustrated embodiment, the flow-forming member 730 is positioned on one side in the width direction of the tray body 710, specifically on an upper rear side.

The tray body 710 is coupled to the tray support members 740. The tray body 710 may be rotatably coupled to the tank unit 100 via the tray support members 740. In addition, the tray body 710 may receive rotational force applied by the tray motor 210 via the tray support members 740.

In the illustrated embodiment, both sides of the tray body 710 in the longitudinal direction are coupled to the tray support members 740.

The tray body 710 may have any shape capable of accommodating ice-making water accommodated in the tray space 720 by surrounding the tray space 720. In the illustrated embodiment, the tray body 710 is formed to have a length in the left-right direction greater than a width in the front-rear direction and to have a height in the up-down direction.

In the illustrated embodiment, the tray body 710 includes a tray bottom surface 711, a recessed surface 712, and a recessed space 713.

The tray bottom surface 711 constitutes one surface in the height direction of the tray body 710, specifically a lower surface in the illustrated embodiment. The tray bottom surface 711 surrounds the tray space 720 from below.

The tray bottom surface 711 may extend obliquely along the longitudinal direction of the tray body 710, specifically in the left-right direction in the illustrated embodiment. That is, in the illustrated embodiment, one side of the tray bottom surface 711 facing a first tray support member 741, that is, a left side, is formed at a higher height than another side facing a second tray support member 742, that is, a right side.

As will be described later, the pipe part 913 is positioned adjacent to a left end of the tray space 720. Accordingly, the tray bottom surface 711 may be regarded as extending downwardly in an inclined manner in a direction toward the flow path member 900.

Thus, residual water accommodated in the tray space 720 may flow toward the pipe part 913 along the tray bottom surface 711 that extends in an inclined manner.

The recessed surface 712 is continuous with the tray bottom surface 711.

The recessed surface 712 is continuous with one side of the tray bottom surface 711 in the longitudinal direction, specifically a right end facing the second tray support member 742. The recessed surface 712 is formed to have a lower height than the tray bottom surface 711. The recessed surface 712 surrounds, from below, the recessed space 713 and an end of the pipe part 913 positioned therein.

Accordingly, residual water that has flowed from left to right along the tray bottom surface 711 may flow to the recessed surface 712 and enter the recessed space 713. That is, the tray bottom surface 711 and the recessed surface 712 may function to cause residual water accommodated in the tray space 720 to flow toward the pipe part 913.

The recessed space 713 may be defined as a space partially surrounded by the recessed surface 712. The recessed space 713 is in fluid communication with the tray space 720 and is positioned at a lower level than the tray space 720. Residual water accommodated in the tray space 720 is discharged through the pipe part 913, and residual water remaining last may be accommodated in the recessed space 713.

The recessed space 713 accommodates a lower end of the pipe part 913. Residual water collected in the recessed space 713 may flow toward the recovery flow path 440 through the lower end of the pipe part 913.

The tray space 720 is a space formed inside the tray body 710. The tray space 720 is surrounded by the tray body 710 on all sides, with the exception that one side in the height direction is open in the illustrated embodiment.

The tray space 720 may be in fluid communication with the purified water tank 110, the cold water tank 120, and the hot water tank 140 through the flow path member 900. Purified water, cold water, or hot water may be supplied to the tray space 720 through the flow path member 900. In this case, due to the shape of the tray body 710, the supplied purified water, cold water, or hot water may fill the tray space 720 starting from a right portion thereof, that is, a portion having a relatively lower height.

The tray space 720 may be in fluid communication with the cold water tank 120 through the flow path member 900. Residual water remaining in the tray space 720 may be discharged through the flow path member 900 and recovered to the cold water tank 120. In this case, due to the shape of the tray body 710, as discharge of residual water continues, the remaining residual water will be understood to be collected in the recessed space 713.

The tray space 720 partially accommodates the evaporator 800. Specifically, the tray space 720 partially accommodates the finger member 820, such that the supplied ice-making water exchanges heat with the finger member 820, that is, the refrigerant flowing therein, to be frozen.

The tray space 720 partially accommodates the flow-forming member 730. The ice-making water accommodated in the tray space 720 may flow due to waves applied by the flow-forming member 730. Accordingly, transparency of the ice formed may be improved.

The tray space 720 may have a shape corresponding to the shape of the tray body 710. In the illustrated embodiment, the tray space 720 is formed to have a length in the left-right direction greater than a width in the front-rear direction and to have a height in the up-down direction.

The flow-forming member 730 is configured to apply waves to the ice-making water accommodated in the tray space 720. Gas mixed in the ice-making water may be separated by waves applied by the flow-forming member 730. Accordingly, transparency of the ice formed may be improved.

The flow-forming member 730 is positioned adjacent to the tray body 710 and is partially accommodated in the tray space 720. In the illustrated embodiment, the flow-forming member 730 is positioned on one side in the width direction of the tray body 710, specifically on a rear side, and a lower portion thereof is accommodated in the tray space 720.

The tray support members 740 are portions by which the tray 700 is coupled to the tank unit 100 or the power unit 200. The tray support members 740 are coupled to the tank unit 100, the power unit 200, and the tray body 710, respectively.

The tray support members 740 may be coupled to both sides in the longitudinal direction of the tray body 710. To this end, in the illustrated embodiment, the tray support members 740 include a first tray support member 741 and a second tray support member 742.

The first tray support member 741 is coupled to one side in the longitudinal direction of the tray body 710, specifically a left end in the illustrated embodiment. The first tray support member 741 is rotatably coupled to the tank unit 100. Accordingly, the first tray support member 741 may be regarded as rotatably coupling the tray body 710 to the tank unit 100.

The second tray support member 742 is coupled to the other side in the longitudinal direction of the tray body 710, specifically a right end in the illustrated embodiment. The second tray support member 742 is coupled to the tray motor 210 and may rotate together therewith. Accordingly, the second tray support member 742 may be regarded as mediating coupling between the tray body 710 and the tray motor 210.

The evaporator 800 provides a flow path through which a refrigerant for ice making flows. In addition, the evaporator 800 may function as a flow path through which hot gas for ice release flows. The evaporator 800 is connected to a refrigerant supply source (not shown) and a hot gas supply source (not shown), respectively, to receive refrigerant and hot gas.

The evaporator 800 is coupled to the tank unit 100. The evaporator 800 may be accommodated in the ice tank 130. The evaporator 800 may be supported by the tank unit 100.

The evaporator 800 is positioned adjacent to the tray 700. The evaporator 800 is accommodated at least partially in the tray space 720 and may be immersed in the ice-making water accommodated in the tray space 720. The refrigerant flowing through the evaporator 800 may exchange heat with the ice-making water to perform ice making.

The evaporator 800 is coupled to the flow path member 900. The evaporator 800 is coupled to the flow path housing 910 and the cover member 920, thereby supporting the flow path member 900.

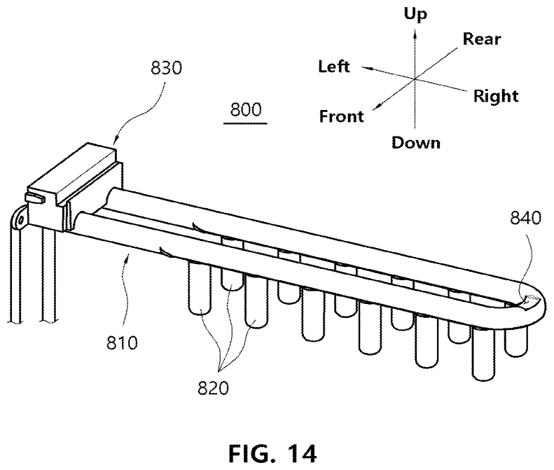

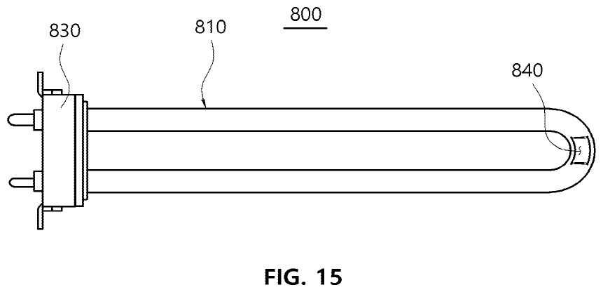

In the embodiment illustrated in FIGS. 14 to 15, the evaporator 800 includes an evaporator body 810, finger members 820, an evaporator support member 830, and an insertion groove 840.

The evaporator body 810 defines an outer shape of the evaporator 800. The evaporator body 810 is a portion to which the evaporator 800 is connected to an external refrigerant supply source (not shown) or a hot gas supply source (not shown). The evaporator body 810 may have a shape corresponding to that of the tray body 710. In the illustrated embodiment, the evaporator body 810 is provided as a single U-shaped pipe having a length in the left-right direction, with a right end portion bent.

A hollow is formed inside the evaporator body 810. The hollow is in fluid communication with the refrigerant supply source (not shown) and the hot gas supply source (not shown). The hollow of the evaporator body 810 may be in fluid communication with a hollow of the finger members 820.

The evaporator body 810 is coupled to the finger members 820. One side of the evaporator body 810 in the height direction, specifically a lower side in the illustrated embodiment, is coupled to a plurality of finger members 820, respectively. The evaporator body 810 may be in fluid communication with the plurality of finger members 820, respectively.

The evaporator body 810 is coupled to the evaporator support member 830. One side of the evaporator body 810 in the longitudinal direction, specifically a left side in the illustrated embodiment, is coupled to and supported by the evaporator support member 830. The evaporator body 810 is coupled to and supported by the tank unit 100 by the evaporator support member 830.

An insertion groove 840 is formed in the evaporator body 810. The insertion groove 840 is formed at an upper portion of the other side of the evaporator body 810 in the longitudinal direction, which is a right end in the illustrated embodiment.

The finger members 820 are portions of the evaporator 800 that are accommodated in the tray space 720 and immersed in ice-making water. The finger members 820 are coupled to the evaporator body 810 so that a refrigerant can flow therethrough. The refrigerant flowing through the finger members 820 may exchange heat with the ice-making water to perform ice making.

The finger members 820 extend in a direction toward the tray space 720, specifically in the up-down direction in the illustrated embodiment. One end of each finger member 820, specifically an upper end in the illustrated embodiment, is coupled to and in fluid communication with a lower side of the evaporator body 810. The other end of each finger member 820, specifically a lower end in the illustrated embodiment, is accommodated in the tray space 720 and may be immersed in the ice-making water.

The finger member 820 may be provided in plurality. The plurality of finger members 820 are spaced apart from each other along the extension direction of the evaporator body 810 and are each coupled to the evaporator body 810 so that the refrigerant can flow therethrough.

The evaporator support member 830 is a portion by which the evaporator 800 is coupled to the tank unit 100. The evaporator support member 830 is coupled to and supported by one side of the tank unit 100 in the longitudinal direction, specifically a left wall in the illustrated embodiment. The evaporator support member 830 is coupled to the evaporator body 810. The evaporator support member 830 is coupled to one side of the evaporator body 810 in the longitudinal direction, specifically a left end in the illustrated embodiment, to support the same.

The insertion groove 840 is a component by which the evaporator 800 is coupled to the flow path member 900. The insertion groove 840 is recessed in an upper surface of the other side of the evaporator body 810 in the longitudinal direction, specifically an upper surface of a right side in the illustrated embodiment. The insertion groove 840 partially accommodates the cover member 920.

The insertion groove 840 may have a shape corresponding to that of the cover member 920. In the illustrated embodiment, the insertion groove 840 is formed as a polygonal plate-shaped space having a rectangular cross-section and a thickness in the up-down direction.

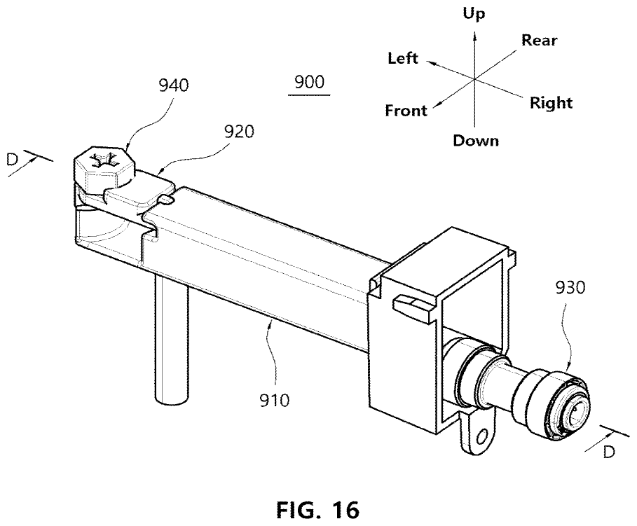

Referring to FIGS. 16 to 23, the water purifier 10 according to an embodiment of the present disclosure includes the flow path member 900.

The flow path member 900 is connected to respective components of the tank unit 100. The flow path member 900 may receive purified water, cold water, or hot water from the purified water tank 110, the cold water tank 120, and the hot water tank 140.

In addition, the flow path member 900 is positioned adjacent to the tray 700 and is at least partially accommodated in the tray space 720. Purified water, cold water, or hot water delivered to the flow path member 900 may be delivered to the tray space 720.

Furthermore, the flow path member 900 may form a flow path through which residual water staying in the tray space 720 is discharged. Residual water in the tray space 720 may be discharged through the flow path member 900 and recovered into the cold water tank 120.

That is, the flow path member 900 connects the tray 700 with other components of the water purifier 10 and may form part of a fluid flow path.

The flow path member 900 is coupled to the tank unit 100. The flow path member 900 is coupled to the flow path member accommodating groove 160 and the flow path member coupling groove 170 and is positioned at least partially in the ice tank 130.

The flow path member 900 is coupled to the valve unit 500. Specifically, the flow path member 900 is coupled to and in fluid communication with the multi-valve 510. Through the multi-valve 510, the flow path member 900 may be fluidically connected to other components of the water purifier 10, that is, the purified water tank 110, the cold water tank 120, and the hot water tank 140.

The flow path member 900 is positioned adjacent to the tray 700. In this case, the flow path member 900 may be at least partially accommodated in the tray space 720. Accordingly, purified water, cold water, or hot water supplied to the tray 700 may be prevented from flowing into other spaces of the ice tank 130. In addition, residual water remaining in the tray 700 may be smoothly discharged through the flow path member 900.

In this case, the flow path member 900 may be accommodated in the tray space 720 at a position adjacent to the recessed space 713. Accordingly, residual water in the tray space 720 may be smoothly discharged, and purified water, cold water, or hot water supplied to the tray space 720 may fill the tray space 720 from a lower side thereof.

The flow path member 900 is coupled to the evaporator 800. The flow path member 900 is accommodated in the insertion groove 840 and may be supported by being coupled to the evaporator body 810.

Therefore, it will be understood that one side of the flow path member 900 in the longitudinal direction, which is a left-right direction in the illustrated embodiment, is supported by being coupled to the tank unit 100, while the other side is supported by being coupled to the evaporator 800.

In the illustrated embodiment, the flow path member 900 includes a flow path housing 910, a cover member 920, a flow path fitting 930, and a fastening member 940.

The flow path housing 910 forms an outer shape of the flow path member 900. The flow path housing 910 is a component through which the flow path member 900 is coupled to the tank unit 100 and the evaporator 800. The flow path housing 910 is coupled to other components of the flow path member 900. In the illustrated embodiment, the flow path housing 910 is coupled to the cover member 920, the flow path fitting 930, and the fastening member 940. The flow path housing 910 is accommodated in the ice tank 130. The flow path housing 910 may be positioned at least partially above the tray body 710.

In the illustrated embodiment, the flow path housing 910 includes a housing body 911, a fitting accommodating portion 912, a pipe part 913, a cover coupling space 914, a cover support portion 915, a cover coupling protrusion 916, an evaporator accommodating space 917, and a tank coupling protrusion 918.

The housing body 911 forms an outer shape of the flow path housing 910. Other components of the flow path housing 910 may be formed on or coupled to the housing body 911. In the illustrated embodiment, the cover coupling space 914 and the tank coupling protrusion 918 are formed in the flow path housing 910. The flow path housing 910 is continuous with the fitting accommodating portion 912, the pipe part 913, the cover support portion 915, and the cover coupling protrusion 916.

The housing body 911 may extend in the same direction as the tray space 720. In the illustrated embodiment, the housing body 911 is formed to have a length in the left-right direction greater than a width in the front-rear direction and to have a height in the up-down direction.

At one side in the longitudinal direction of the housing body 911, which is a left side in the illustrated embodiment, the cover support portion 915 and the cover coupling protrusion 916 are continuous, and the cover coupling space 914 and the evaporator accommodating space 917 are formed. At the other side in the longitudinal direction of the housing body 911, which is a right side in the illustrated embodiment, the fitting accommodating portion 912 is continuous. At one side in the height direction of the housing body 911, which is a lower side in the illustrated embodiment, the pipe part 913 is coupled.

The fitting accommodating portion 912 accommodates and supports the flow path fitting 930. The fitting accommodating portion 912 is continuous with the above-described one side in the longitudinal direction of the housing body 911, which is the right side in the illustrated embodiment. A space is formed inside the fitting accommodating portion 912 to accommodate the flow path fitting 930. An inner circumferential surface of the fitting accommodating portion 912 surrounding the space may support the flow path fitting 930.

The pipe part 913 may pass through the space of the fitting accommodating portion 912. The flow path fitting 930 accommodated in the fitting accommodating portion 912 may be coupled to and in fluid communication with the pipe part 913.

The fitting accommodating portion 912 is coupled to the tank unit 100. The fitting accommodating portion 912 is inserted into the flow path member accommodating groove 160 and may be supported by an inner circumferential surface of the tank unit 100 surrounding the flow path member accommodating groove 160.

The pipe part 913 fluidically communicates between the tray space 720 and the multi-valve 510. A hollow is formed through an interior of the pipe part 913. Both ends of the hollow are open and may be in fluid communication with the outside.

The pipe part 913 is coupled to the housing body 911. In the illustrated embodiment, the pipe part 913 is coupled to one side of the housing body 911 in the height direction, that is a lower side. The pipe part 913 is coupled to the fitting accommodating portion 912. The pipe part 913 passes through the space formed in the fitting accommodating portion 912 and may be exposed rightward along the longitudinal direction, which is a left-right direction in the illustrated embodiment.

The pipe part 913 is coupled to the flow path fitting 930. A portion of the pipe part 913 that passes through the fitting accommodating portion 912 and is exposed to the outside, which is a right end in the illustrated embodiment, may be coupled to and in fluid communication with the flow path fitting 930. The end of the pipe part 913 may be coupled to the multi-valve 510 through the flow path fitting 930.

The pipe part 913 may be divided into a plurality of portions. Among the plurality of portions, one portion may be accommodated in and in fluid communication with the tray space 720. Another portion among the plurality of portions may be continuous with and in fluid communication with the one portion and may be coupled to the flow path fitting 930.

In the illustrated embodiment, the pipe part 913 includes one portion extending in the up-down direction and another portion extending in the left-right direction. The one portion and the other portion may be continuous with each other while forming a predetermined angle. In one embodiment, the predetermined angle may be a right angle.

The one portion is partially accommodated in the tray space 720. In this case, a lower end of the one portion is accommodated in the recessed space 713 and may be positioned adjacent to the recessed surface 712. The lower end of the one portion is open and may be in fluid communication with the tray space 720 or the recessed space 713. An upper end of the one portion is continuous with and in fluid communication with the other portion.

The other portion is coupled to the housing body 911. A left end of the other portion is in fluid communication with the upper end of the one portion. An opposite end of the other portion passes through the fitting accommodating portion 912 and is coupled to the flow path fitting 930.

The cover coupling space 914 is a portion where the flow path housing 910 is coupled to the cover member 920. A cover body 921 is inserted and coupled in the cover coupling space 914. The cover coupling space 914 is recessed in the other side in the longitudinal direction of the housing body 911, specifically in a left side surface in the illustrated embodiment. The cover coupling space 914 may be defined by being surrounded by an upper surface, a left surface, and a lower surface of the housing body 911.

In the illustrated embodiment, the cover coupling space 914 includes a limiting groove 914a.

The limiting groove 914a accommodates a housing coupling protrusion 923 of the cover member 920. That is, the cover body 921 is accommodated in the cover coupling space 914, and the housing coupling protrusion 923 is inserted into the limiting groove 914a. Accordingly, the cover member 920 may be prevented from rotating relative to the flow path housing 910. The limiting groove 914a is recessed at an end of a surface surrounding the cover coupling space 914 from an upper side.

The cover support portion 915 supports a part of the evaporator body 810. An inner side of a right end portion of the evaporator body 810 accommodated in the evaporator accommodating space 917, that is, a rounded portion, may be supported by the cover support portion 915. The cover support portion 915 is formed as a rounded curved surface that is convex toward the right so as to correspond to a shape of the inner side of the right end portion of the evaporator body 810.

The cover support portion 915 is continuous with the housing body 911. The cover support portion 915 may be continuous with the other side in the longitudinal direction of the housing body 911, that is, a left end thereof.

In the illustrated embodiment, the cover support portion 915 includes a housing through hole 915a.

The housing through hole 915a is recessed inside the cover support portion 915 in the height direction, specifically in the up-down direction in the illustrated embodiment. The fastening member 940 may be inserted and coupled into the housing through hole 915a.

The cover coupling protrusion 916 is coupled to a housing insertion groove 924 of the cover member 920. The cover coupling protrusion 916 protrudes from an outer surface of the cover support portion 915, specifically from a left surface in the illustrated embodiment. The cover coupling protrusion 916 may be snap-fitted to the housing insertion groove 924. For this purpose, an upper surface of the cover coupling protrusion 916 may extend to be inclined toward a lower-left direction, and a lower surface thereof may extend horizontally toward the left.

The evaporator accommodating space 917 accommodates the above-described part of the evaporator body 810. Specifically, the evaporator accommodating space 917 accommodates a right end portion of the evaporator body 810, that is, a rounded portion.

The evaporator accommodating space 917 is defined by being surrounded by a portion of a lower surface of the housing body 911, a left surface of the housing body 911, and the cover support portion 915. The right end portion of the evaporator body 810 accommodated in the evaporator accommodating space 917 may be supported by being surrounded by the housing body 911 and the cover support portion 915.

The tank coupling protrusions 918 protrude from respective sides in the width direction of the fitting accommodating portion 912, specifically from front and rear side surfaces in the illustrated embodiment. The tank coupling protrusions 918 extend in the longitudinal direction of the fitting accommodating portion 912, specifically in the left-right direction in the illustrated embodiment.

The tank coupling protrusions 918 are inserted and coupled into the flow path member coupling grooves 170. In the illustrated embodiment, a pair of tank coupling protrusions 918 are provided and may be respectively inserted and coupled into a pair of flow path member coupling grooves 170.

Accordingly, one side in the longitudinal direction of the flow path housing 910, that is, a left side, may be coupled to and supported by the evaporator body 810, and the other side in the longitudinal direction thereof, that is, a right side, may be coupled to and supported by the tank unit 100.

The cover member 920 is another component by which the flow path member 900 is coupled to the evaporator 800. The cover member 920 is coupled to the flow path housing 910 and may cover the right end portion of the evaporator body 810.

Accordingly, coupling force between the flow path member 900 and the evaporator 800 is improved, so that the flow path member 900 may be stably supported. The cover member 920 may be maintained in a state of being coupled to the flow path housing 910 by the fastening member 940.

In the illustrated embodiment, the cover member 920 includes a cover body 921, a cover boss portion 922, a housing coupling protrusion 923, a housing insertion groove 924, a cover through hole 925, and a limiting protrusion 926.

The cover body 921 constitutes a part of an outer shape of the cover member 920. The cover body 921 is configured to cover the above-described end portion of the evaporator body 810. Other components of the cover member 920 are coupled to or formed on the cover body 921. In the illustrated embodiment, the cover body 921 has the cover boss portion 922, the cover through hole 925, and the limiting protrusion 926 formed thereon, and is continuous with the housing coupling protrusion 923.

The cover body 921 is coupled to the cover coupling space 914. One side in the longitudinal direction of the cover body 921, specifically a right end in the illustrated embodiment, is accommodated in the cover coupling space 914. In the illustrated embodiment, the cover body 921 is formed in a plate shape having a length in the left-right direction greater than a width in the front-rear direction and having a thickness in the up-down direction.

The cover boss portion 922 and the limiting protrusion 926 are positioned on an upper side of the cover body 921. The other side in the longitudinal direction of the cover body 921, specifically a left end in the illustrated embodiment, is continuous with the housing coupling protrusion 923, and the cover through hole 925 is formed through an interior of the cover body 921.

The cover boss portion 922 is in contact with an upper surface of the housing body 911 that surrounds the cover coupling space 914 from an upper side. Due to contact between the cover boss portion 922 and the upper surface of the housing body 911, relative rotation between the cover member 920 and the flow path housing 910 may be prevented. The cover boss portion 922 protrudes upward from the upper side of the cover body 921.

The limiting protrusion 926 is continuous with one side in the longitudinal direction of the cover boss portion 922, specifically a rear side in the illustrated embodiment.

The housing coupling protrusion 923 is a portion by which the cover member 920 is coupled to the flow path housing 910. The housing coupling protrusion 923 extends downward from the one side in the longitudinal direction of the cover body 921, that is, a left end thereof.

The housing coupling protrusion 923 may have a shape corresponding to a shape of the cover support portion 915. In the illustrated embodiment, the housing coupling protrusion 923 is formed to have an arc-shaped cross-section that is convex toward the left and a height in the up-down direction. The housing coupling protrusion 923 may cover the cover support portion 915 from an outer side.

The housing insertion groove 924 is formed through an interior of the housing coupling protrusion 923.

The housing insertion groove 924 accommodates the cover coupling protrusion 916. The housing insertion groove 924 is formed through the housing coupling protrusion 923 in the thickness direction thereof, specifically in the left-right direction in the illustrated embodiment.

The housing insertion groove 924 may have a shape corresponding to a shape of the cover coupling protrusion 916 or the housing coupling protrusion 923. In the illustrated embodiment, the housing insertion groove 924 is formed as a space having an arc-shaped cross-section that is convex toward the left and having a height in the up-down direction.

The cover coupling protrusion 916 accommodated in the housing insertion groove 924 may be supported by an inner circumferential surface of the housing coupling protrusion 923. Accordingly, as described above, the housing insertion groove 924 and the cover coupling protrusion 916 may be snap-fitted.

The cover through hole 925 is a portion where the cover member 920 is coupled to the fastening member 940. The cover through hole 925 is formed through the cover body 921 in the up-down direction at one side in the longitudinal direction thereof, specifically at a left portion in the illustrated embodiment. The cover through hole 925 is positioned between the cover boss portion 922 and the housing coupling protrusion 923 along the longitudinal direction of the cover body 921. The cover through hole 925 is positioned to overlap the housing through hole 915a in the up-down direction.

The limiting protrusion 926 is inserted into the limiting groove 914a. The limiting protrusion 926 protrudes from an upper surface of a right side of the cover body 921. The limiting protrusion 926 is continuous with a right end of the cover boss portion 922. As described above, relative rotation between the cover member 920 and the flow path housing 910 is prevented by coupling between the limiting protrusion 926 and the limiting groove 914a.

The flow path fitting 930 is a portion by which the flow path member 900 is coupled to the multi-valve 510. The flow path fitting 930 is accommodated in a space formed inside the cover member 920 and is coupled to and fluidically communicates with the other end of the pipe part 913 of the flow path housing 910, that is, a right end thereof. The flow path fitting 930 may be directly connected to the multi-valve 510 or indirectly connected thereto through a separate flow path.

The fastening member 940 couples the flow path housing 910 and the cover member 920. Specifically, when the cover member 920 is coupled to the flow path housing 910 in a state in which the right end portion of the evaporator body 810 is accommodated in the evaporator accommodating space 917, the housing through hole 915a and the housing insertion groove 924 are disposed to overlap each other in the up-down direction. The fastening member 940 may be inserted through the housing insertion groove 924 and inserted and coupled into the housing through hole 915a.

The fastening member 940 may be provided in any form capable of coupling the flow path housing 910 and the cover member 920. In one embodiment, the fastening member 940 may be provided as a screw member.

Referring to FIGS. 26 and 27, various flow paths formed inside the water purifier 10 according to an embodiment of the present disclosure are illustrated by way of example.

First, a first flow F1 may be defined as a flow in which residual water remaining in the tray space 720 is discharged and recovered into the cold water tank 120. When the recovery pump 320 operates, a conveying force in a direction toward the cold water tank 120 is applied to the residual water through the recovery flow path 440 and the multi-valve 510 and the pipe part 913 connected thereto.

Accordingly, residual water accommodated in the tray space 720 may sequentially pass through the pipe part 913, the flow path fitting 930, the multi-valve 510, and the recovery flow path 440 and be recovered into the cold water tank 120.

In this case, due to the shape of the tray body 710, that is, because a right portion where the lower end of the pipe part 913 is positioned is formed at a lower height, residual water remaining in the tray space 720 may be collected in the recessed space 713. Accordingly, an amount of residual water remaining in the tray space 720 without being recovered may be minimized.

In this case, as described above, the recovered residual water may flow into an arbitrary position of the cold water tank 120. In the illustrated embodiment of FIG. 27, it is assumed that the residual water is recovered to a lower portion of the cold water tank 120, that is, a position in which cold water having a relatively lowest temperature is accommodated. Alternatively, as described above, the residual water may flow into an arbitrary position of the cold water tank 120.

In addition, a second flow F2 may be defined as a flow in which cold water accommodated in the cold water tank 120 is provided to the tray 700. When the cold water pump 310 operates, the cold water accommodated in the cold water tank 120 may be discharged and flow toward the cold water valve 520.

When the cold water valve 520 is controlled by the controller C to be connected to the multi-valve 510, the cold water may flow along the cold water supply flow path 432, sequentially pass through the multi-valve 510 and the pipe part 913, and be provided to the tray space 720.

Furthermore, a third flow F3 may be defined as a flow in which hot water accommodated in the hot water tank 140 is provided to the tray 700. When the controller C operates the hot water tank 140 itself or an unillustrated hot water pump (not shown), the hot water accommodated in the hot water tank 140 may be discharged and flow along the hot water supply flow path 412. The hot water may sequentially pass through the multi-valve 510 and the pipe part 913 and be provided to the tray space 720.

In this case, the hot water provided to the tray space 720 may sterilize the tray body 710. Thereafter, when the controller C operates the tray motor 210 to rotate the tray 700, the hot water that has sterilized the tray body 710 may fall and be discharged from the tray 700.

Accordingly, the water purifier 10 according to an embodiment of the present disclosure may recover residual water remaining in the tray 700 through a separate recovery flow path 440 and reuse the residual water as cold water or ice-making water. As a result, as described above, the water purifier 10 according to an embodiment of the present disclosure may achieve various effects.

### 2. Description of a Control Method of the Water Purifier 10 According to an Embodiment of the Present Disclosure

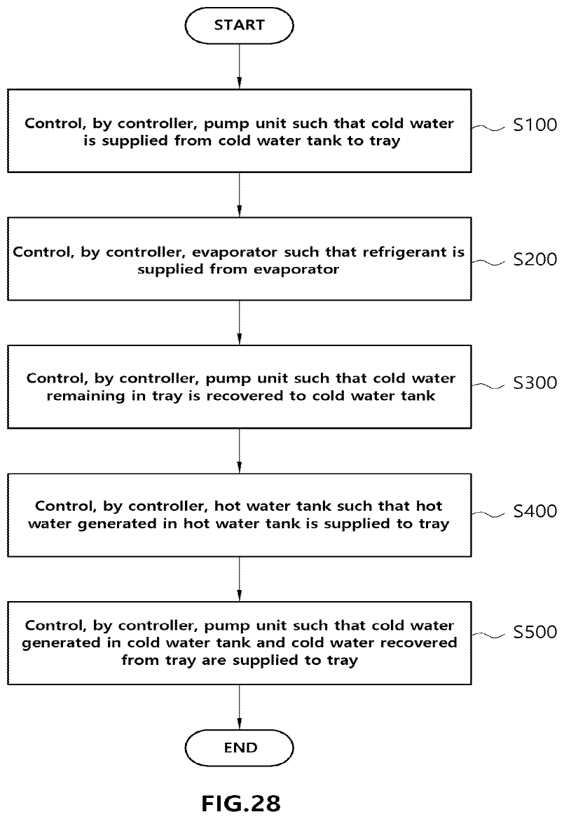

Referring to FIGS. 28 to 33, a flow of a control method of a water purifier 10 according to an embodiment of the present disclosure is illustrated by way of example. The control method of the water purifier 10 according to the illustrated embodiment may be performed by the respective components of the water purifier 10 described above.

In the illustrated embodiment of FIG. 28, the control method of the water purifier 10 includes: a step (S100) in which the controller C controls the pump unit 300 such that cold water is supplied from the cold water tank 120 to the tray 700; a step (S200) in which the controller C controls the evaporator 800 such that a refrigerant is supplied from the evaporator 800; a step (S300) in which the controller C controls the pump unit 300 such that cold water remaining in the tray 700 is recovered to the cold water tank 120; a step (S400) in which the controller C controls the hot water tank such that hot water generated in the hot water tank is supplied to the tray 700; and a step (S500) in which the controller C controls the pump unit 300 such that cold water generated in the cold water tank 120 and cold water recovered from the tray 700 are supplied to the tray 700.

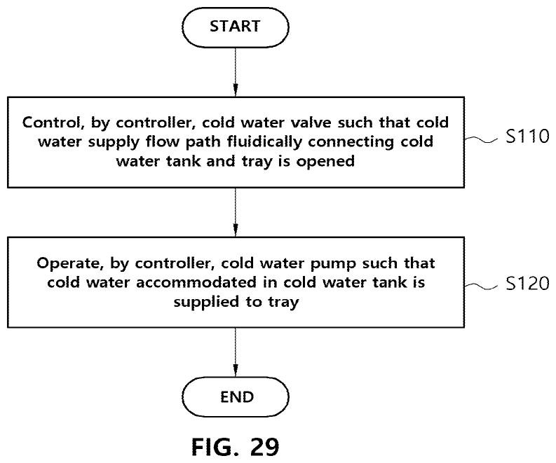

Referring to FIG. 29, a detailed flow of the step (S100) in which the controller C controls the pump unit 300 such that cold water is supplied from the cold water tank 120 to the tray 700 is illustrated by way of example. The step (S100) is a step in which cold water accommodated in the cold water tank 120 is supplied to the tray 700 as ice-making water.

First, the controller C controls the cold water valve 520 such that the cold water supply flow path 432 fluidically connecting the cold water tank 120 and the tray 700 is opened (S110). Accordingly, the cold water tank 120 is connected to the multi-valve 510, while fluid communication with the cold water discharge member 630 is blocked.

Next, the controller C operates the cold water pump 310 such that the cold water accommodated in the cold water tank 120 is supplied to the tray 700 (S120). Accordingly, a transfer force is applied to the cold water accommodated in the cold water tank 120, and the cold water may be supplied to the tray space 720 through the cold water pump 310, the cold water supply flow path 432, and the multi-valve 510, via the flow path member 900.

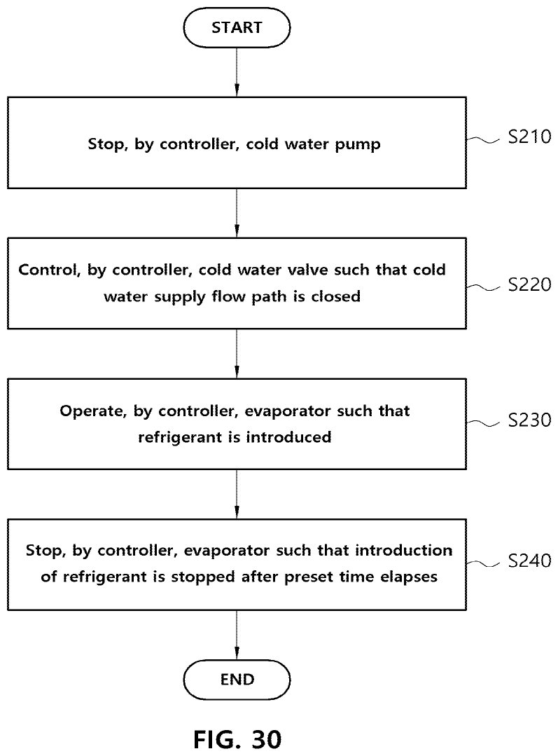

Referring to FIG. 30, a detailed flow of the step (S200) in which the controller C controls the evaporator 800 such that a refrigerant is supplied from the evaporator 800 is illustrated by way of example. The step (S200) is a step in which the ice-making water accommodated in the tray 700 is cooled so that ice-making is performed.

First, the controller C stops the cold water pump 310 (S210). Accordingly, further discharge of cold water from the cold water tank 120 may be stopped.

Next, the controller C controls the cold water valve 520 such that the cold water supply flow path 432 is closed (S220). Accordingly, further inflow of cold water into the tray 700 may be stopped.

When the controller C operates the evaporator 800 such that a refrigerant is introduced (S230), the refrigerant is introduced into the evaporator 800 from an external refrigerant supply source (not shown). The introduced refrigerant flows along the evaporator 800 and cools the ice-making water accommodated in the tray space 720.

After a preset time sufficient to generate ice from the ice-making water accommodated in the tray space 720 has elapsed, the controller C stops the evaporator 800 such that introduction of the refrigerant is stopped (S240). Accordingly, most of the ice-making water accommodated in the tray space 720 is converted into ice, and a portion of residual water remains.

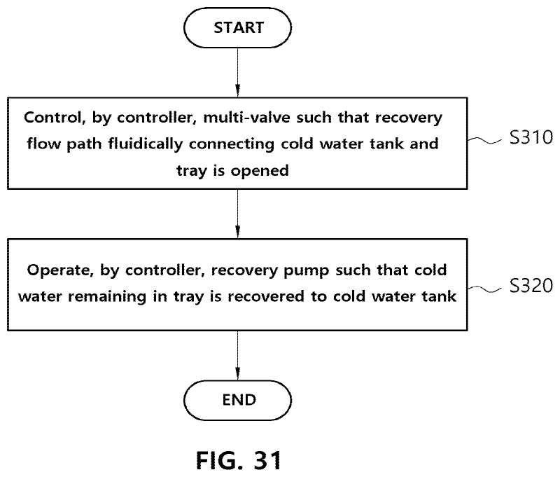

Referring to FIG. 31, a detailed flow of the step (S300) in which the controller C controls the pump unit 300 such that cold water remaining in the tray 700 is recovered to the cold water tank 120 is illustrated by way of example. The step (S300) is a step in which residual water remaining in the tray space 720 after ice-making is discharged through the flow path member 900 and recovered to the cold water tank 120.

First, the controller C controls the multi-valve 510 such that the recovery flow path 440 fluidically connecting the cold water tank 120 and the tray 700 is opened (S310). Accordingly, the pipe part 913, the multi-valve 510, the recovery flow path 440, and the cold water tank 120 are in fluid communication with each other.

In this state, when the controller C operates the recovery pump 320 such that the cold water remaining in the tray 700 is recovered to the cold water tank 120 (S320), a transfer force is applied to the residual water remaining in the tray space 720. Accordingly, the residual water may pass sequentially through the pipe part 913, the multi-valve 510, and the recovery flow path 440 and be recovered to the cold water tank 120.

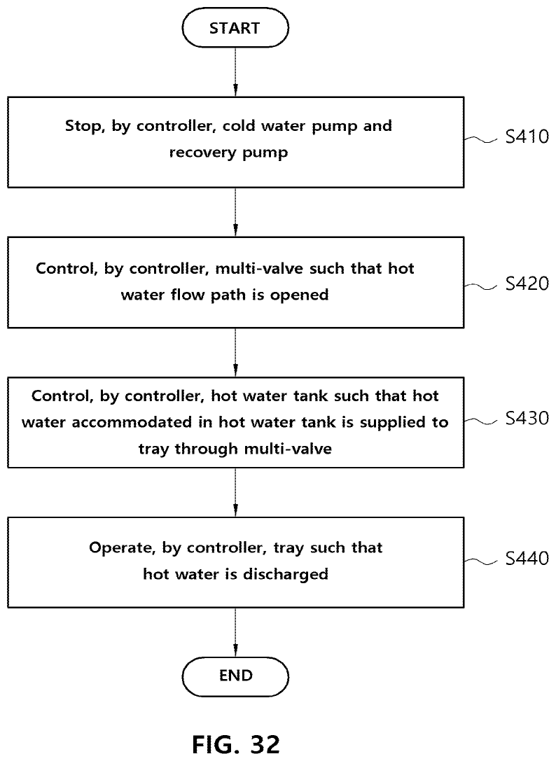

Referring to FIG. 32, a detailed flow of the step (S400) in which the controller C controls the hot water tank such that hot water generated in the hot water tank is supplied to the tray 700 is illustrated by way of example. The step (S400) is a step in which, after recovery of the residual water is completed, hot water is supplied to sterilize the tray body 710.

The step (S400) may be selectively performed. That is, after the step (S300) in which the controller C controls the pump unit 300 such that cold water remaining in the tray 700 is recovered to the cold water tank 120, the step (S500) in which the controller C controls the pump unit 300 such that cold water generated in the cold water tank 120 and cold water recovered from the tray 700 are supplied to the tray 700 may be immediately performed.

First, the controller C stops the cold water pump 310 and the recovery pump 320 (S410). Accordingly, inflow of cold water into the tray space 720 and outflow of residual water from the tray space 720 are stopped.

The controller C controls the multi-valve 510 such that the hot water flow path 410 is opened (S420). Accordingly, the hot water tank 140, the multi-valve 510, and the flow path member 900 connected thereto may be connected to each other.

The controller C controls the hot water tank 140 such that the hot water accommodated in the hot water tank 140 is supplied to the tray 700 through the multi-valve 510 (S430). Accordingly, the hot water accommodated in the hot water tank 140 may flow toward the tray 700. In an embodiment in which a separate hot water pump is provided, the controller C may be configured to operate a hot water pump (not shown).

After a time sufficient to sterilize the tray body 710 has elapsed, the controller C operates the tray such that the hot water is discharged (S440). Accordingly, the tray 700 is rotated, and the hot water may be discharged from the tray space 720.

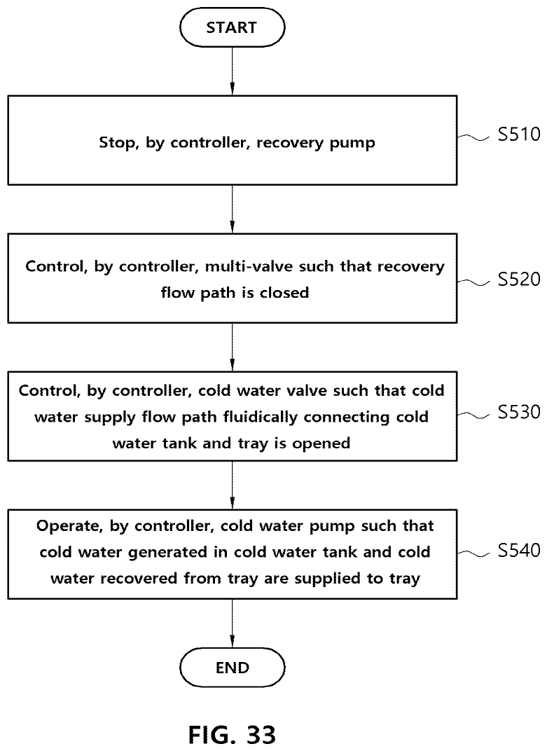

Referring to FIG. 33, a detailed flow of the step (S500) in which the controller C controls the pump unit 300 such that cold water generated in the cold water tank 120 and cold water recovered from the tray 700 are supplied to the tray 700 is illustrated by way of example. The step (S500) is a step in which the recovered residual water is supplied again to the tray 700 as ice-making water.

When the controller C stops the recovery pump 320 (S510), the process of recovering residual water remaining in the tray space 720 is stopped.

When the controller C controls the multi-valve 510 such that the recovery flow path 440 is closed (S520), the flow in which the recovered residual water is introduced into the cold water tank 120 is stopped.

Next, the controller C controls the cold water valve 520 such that the cold water supply flow path 432 fluidically connecting the cold water tank 120 and the tray 700 is opened (S530).

When the controller C operates the cold water pump 310 such that cold water generated in the cold water tank 120 and cold water recovered from the tray 700 are supplied to the tray 700 (S540), the cold water generated in the cold water tank 120 and the recovered residual water may be supplied to the tray space 720 sequentially through the cold water supply flow path 432, the multi-valve 510, and the flow path member 900.

According to the water purifier 10 and the control method thereof according to the embodiment of the present disclosure described above, residual water generated after ice-making is recovered to the cold water tank 120 and may be reused as cold water or ice-making water.

Accordingly, meaningless waste of the generated residual water may be minimized.

In addition, the amount of power required to generate cold water is reduced, and the amount of use of a filter (not shown) for generating purified water to be converted into cold water may be reduced. Accordingly, service lives of the cold water tank 120 and the filter (not shown) may be increased.

Furthermore, in one embodiment, hot water may be supplied to the tray 700 as sterilizing water. Accordingly, hygienic conditions of the tray 700 are improved, and hygiene of the ice produced may also be improved.

Although exemplary embodiments of the present disclosure have been described, the spirit of the present disclosure is not limited to the embodiments set forth herein. Those of ordinary skill in the art who understand the spirit of the present disclosure may easily propose other embodiments through supplement, change, removal, addition, etc. of elements within the scope of the same inventive concept, but such embodiments will also fall within the scope of the present disclosure.

### DESCRIPTION OF SYMBOLS

10: water purifier 100: tank unit
110: purified water tank 120: cold water tank
121: cooling device 122: baffle member
130: ice tank 140: hot water tank
150: partition member 160: flow path member accommodating groove
170: flow path member coupling groove 200: power unit
210: tray motor 220: screw motor
300: pump unit 310: cold water pump
320: recovery pump 400: flow path unit
410: hot water flow path 411: hot water discharge flow path
412: hot water supply flow path 420: purified water flow path
421: purified water discharge flow path 422: purified water supply flow path
430: cold water flow path 431: cold water discharge flow path
432: cold water supply flow path 440: recovery flow path
500: valve unit 510: multi-valve
520: cold water valve 600: discharge unit
610: hot water discharge member 620: purified water discharge member
630: cold water discharge member 700: tray
710: tray body 711: tray bottom surface
712: recessed surface 713: recessed space
720: tray space 730: flow-forming member
740: tray support member 741: first tray support member
742: second tray support member 800: evaporator
810: evaporator body 820: finger member
830: evaporator support member 840: insertion groove
900: flow path member 910: flow path housing
911: housing body 912: fitting accommodating portion
913: pipe part 914: cover coupling space
914a: limiting groove 915: cover support portion
915a: housing through hole 916: cover coupling protrusion
917: evaporator accommodating space 918: tank coupling protrusion
920: cover member 921: cover body
922: cover boss portion 923: housing coupling protrusion
924: housing insertion groove 925: cover through hole
926: limiting protrusion 930: flow path fitting
940: fastening member F1: first flow
F2: second flow F3: third flow
C: controller

What is claimed is:

1. A water purifier, comprising:
a cold water tank configured to receive purified water and cool the purified water to generate cold water;
a tray connected to the cold water tank and configured to receive the cold water, the tray having a tray space formed therein to accommodate the received cold water;
a valve unit connected to the cold water tank;
a flow path member partially accommodated in the tray space and connected to the valve unit to provide the cold water to the tray space; and
a recovery pump connected to the valve unit and configured to provide a conveying force to the cold water remaining in the tray space,
wherein the recovery pump is connected to the cold water tank and configured to recover the cold water remaining in the tray space to the cold water tank.

2. The water purifier of claim 1,
wherein the tray comprises:
a tray bottom surface surrounding the tray space from below;
a recessed surface continuous with the tray bottom surface and positioned lower than the tray bottom surface; and
a recessed space surrounded at a lower side by the recessed surface and in fluid communication with the tray space,
wherein the flow path member is positioned adjacent to the recessed space and disposed adjacent to a water surface of the cold water collected in the recessed space.

3. The water purifier of claim 2, wherein the tray bottom surface extends in an inclined manner from one side opposite to the recessed space toward the recessed space.

4. The water purifier of claim 1, wherein the flow path member comprises a flow path housing having one portion accommodated in the tray and another portion connected to the valve unit.

5. The water purifier of claim 4,
wherein the flow path housing comprises:
a housing body extending in a first direction; and
a pipe part positioned adjacent to the housing body and having one end in an extension direction positioned in the tray space and another end in the extension direction connected to the valve unit to form a flow path through which the cold water is discharged from the tray, and
wherein the flow path member further comprises a flow path fitting coupled to the other end of the pipe part and connected to the valve unit.

6. The water purifier of claim 4,
further comprising an evaporator partially accommodated in the tray space and forming a refrigerant flow path,
wherein the flow path member comprises a cover member covering at least a portion of the evaporator from above and coupled to the flow path housing, and
wherein the flow path housing comprises:
a housing body extending in a first direction;
a cover support portion positioned to be spaced apart from one end of the housing body along the first direction and configured to support the cover member from below; and
an evaporator accommodating space formed between the housing body and the cover support portion and configured to accommodate the evaporator.

7. The water purifier of claim 1, further comprising:
a hot water tank configured to receive purified water and generate hot water; and
a flow path unit connecting the hot water tank, the cold water tank, and the flow path member,
wherein the valve unit comprises a multi-valve connected to the hot water tank, the cold water tank, and the flow path member, respectively, and
wherein the cold water tank is connected to the multi-valve at a plurality of points by a plurality of separated flow path units.

8. The water purifier of claim 7,
wherein the flow path unit comprises:
a hot water supply flow path connecting the hot water tank and the multi-valve to provide the hot water to the multi-valve;
a cold water supply flow path connecting the cold water tank and the multi-valve to provide the cold water to the multi-valve; and
a recovery flow path configured independently from the cold water supply flow path and connecting the cold water tank and the multi-valve to provide the cold water recovered from the tray space to the cold water tank.

9. The water purifier of claim 8, wherein the recovery pump is installed in the recovery flow path.

10. The water purifier of claim 8, wherein the multi-valve is provided as a four-way valve and is connected to the flow path member, the hot water supply flow path, the cold water supply flow path, and the recovery flow path, respectively.

11. The water purifier of claim 8, wherein the recovery flow path is connected to the cold water tank at a position closer to a lower side of the cold water tank in a height direction.

12. The water purifier of claim 8,
wherein the cold water tank comprises a baffle member partitioning an internal space thereof into a plurality of small spaces continuously arranged in a zigzag shape, and
wherein the recovery flow path is connected to the cold water tank at a position adjacent to any one of the plurality of small spaces partitioned by the baffle member.

13. A method for controlling a water purifier, comprising:
(a) controlling, by a controller, a pump unit such that cold water is supplied from a cold water tank to a tray;
(b) controlling, by the controller, an evaporator such that a refrigerant is supplied to the evaporator; and
(c) controlling, by the controller, the pump unit such that cold water remaining in the tray is recovered to the cold water tank.

14. The method of claim 13,
wherein the step (a) comprises:
(a1) controlling, by the controller, a cold water valve such that a cold water supply flow path fluidically connecting the cold water tank and the tray is opened; and
(a2) operating, by the controller, a cold water pump such that the cold water accommodated in the cold water tank is supplied to the tray.

15. The method of claim 13,
wherein the step (b) comprises:
(b1) stopping, by the controller, the cold water pump;
(b2) controlling, by the controller, a cold water valve such that the cold water supply flow path is closed;
(b3) operating, by the controller, the evaporator such that the refrigerant is introduced; and
(b4) after a preset time has elapsed, stopping, by the controller, the evaporator such that introduction of the refrigerant is stopped.

16. The method of claim 13,
wherein the step (c) comprises:
(c1) controlling, by the controller, a multi-valve such that a recovery flow path fluidically connecting the cold water tank and the tray is opened; and
(c2) operating, by the controller, a recovery pump such that the cold water remaining in the tray is recovered to the cold water tank.

17. The method of claim 13, further comprising, after the step (c):
(d) controlling, by the controller, the pump unit such that cold water generated in the cold water tank and cold water recovered from the tray are supplied to the tray.

18. The method of claim 17,
wherein the step (d) comprises:
(d1) stopping, by the controller, the recovery pump;
(d2) controlling, by the controller, a multi-valve such that a recovery flow path is closed;
(d3) controlling, by the controller, a cold water valve such that a cold water supply flow path fluidically connecting the cold water tank and the tray is opened; and
(d4) operating, by the controller, a cold water pump such that cold water generated in the cold water tank and cold water recovered from the tray are supplied to the tray.

19. The method of claim 13, further comprising, after the step (c) and before the step (d):
(e) controlling, by the controller, a hot water tank such that hot water generated in the hot water tank is supplied to the tray.

20. The method of claim 19,
wherein the step (e) comprises:
(e1) stopping, by the controller, a cold water pump and a recovery pump;
(e2) controlling, by the controller, a multi-valve such that a hot water flow path is opened;
(e3) controlling, by the controller, the hot water tank such that hot water accommodated in the hot water tank is supplied to the tray through the multi-valve; and
(e4) operating, by the controller, the tray such that the hot water is discharged.
